(19) United States
(12) Patent Application Publication
(10) Pub. No.: US 2018/0059812 A1
(43) Pub. Date: Mar. 1, 2018

(54) METHOD FOR PROVIDING VIRTUAL SPACE, METHOD FOR PROVIDING VIRTUAL EXPERIENCE, PROGRAM AND RECORDING MEDIUM THEREFOR

(71) Applicant: COLOPL, INC., Tokyo (JP)

(72) Inventors: Atsushi INOMATA, Kanagawa (JP); Yuki KONO, Tokyo (JP); Hisaki SATO, Tokyo (JP)

(21) Appl. No.: 15/681,427

(22) Filed: Aug. 21, 2017

(30) Foreign Application Priority Data
Aug. 22, 2016 (JP) 2016-162243
Aug. 22, 2016 (JP) 2016-162245
Sep. 2, 2016 (JP) 2016-172201

(51) Int. Cl. G06F 3/0346; G06F 3/03; G06F 3/01

(52) U.S. Cl. CPC G06F 3/0346; G06F 3/013; G06F 3/0325

(57) ABSTRACT

A method of providing a virtual space to a user includes generating a virtual space. The method further includes displaying a field-of-view image of the virtual space using a head mounted display (HMD). The method further includes displaying an input object in the virtual space. The method further includes displaying, in the virtual space, a virtual body corresponding to a part of a body of the user other than the user's head. The method further includes moving the virtual body in synchronization with a detected movement of the part of the body of the user. The method further includes detecting movement of the input object, using the virtual body, to a determination region in the virtual space. The method further includes receiving, in response to a detection that the input object is moved to the determination region, an input associated with information contained in the input object.

### RELATED APPLICATIONS

The present application claims priority to Japanese application Nos. 2016-162243 filed Aug. 22, 2016, 2016-172201 filed Sep. 2, 2016 and 2016-162245 filed Aug. 22, 2016, the disclosures of which are hereby incorporated by reference herein in their entirety.

### BACKGROUND

This disclosure relates to a method of providing a virtual space, a method of providing a virtual experience, and a system and a recording medium therefor.

In Japanese Patent No. 5876607, there is described a method of enabling predetermined input by directing a line of sight to a widget arranged in a virtual space.

In Japanese Patent Application Laid-open No. 2013-258614, there is disclosed a technology for causing a user to recognize content reproduced in a virtual space with a head mounted display (HMD).

In Japanese Patent No. 5876607, there is room for improving a virtual experience. In particular, the virtual experience may be improved by causing the user to physically feel execution of input on a user interface (UI).

In the related art described above, when the user moves the HMD, a location recognized by the user in the virtual space can be changed, and thus the user can be more immersed in the virtual space. However, there is a demand for a measure to improve operability in the virtual space while improving the sense of immersion in the virtual space so that, when an event has occurred in a blind spot of the user in the virtual space, the user can intuitively recognize a direction in which the event has occurred.

### SUMMARY

This disclosure has been made to help solve the problems described above, and an object of at least one embodiment of this disclosure is to improve a virtual experience.

According to at least one embodiment of this disclosure, there is provided a method of providing a virtual space to a user wearing a head mounted display (hereinafter referred to as “HMD”) on a head of the user. The method includes generating a field-of-view image to be output to the head mounted display in the virtual space based on movement of the head mounted display. The method further includes generating an input object with which an input item is associated in the virtual space. The method further includes generating a virtual body configured to move in synchronization with movement of a part of a body of the user other than the head in the virtual space. The method further includes detecting that the input object is moved to a determination region in the virtual space with the virtual body. The method further includes receiving, in response to a detection that the input object is moved to the determination region, input of the input item associated with the input object.

Further, according to at least one embodiment of this disclosure, there is provided a method of providing a virtual experience to a user wearing a head mounted display on a head of the user. The method includes generating an input object with which an input item is associated. The method further includes detecting that the input object is moved to a determination region by a part of a body of the user other than the head. The method further includes receiving, in response to a detection that the input object is moved to the determination region, input of the input item associated with the input object.

According to this disclosure, a virtual experience can be improved.

### BRIEF DESCRIPTION OF THE DRAWINGS

FIG. 1 is a diagram of a configuration of an HMD system according to at least one embodiment of this disclosure.

FIG. 2 is a diagram of a hardware configuration of a control circuit unit according to at least one embodiment of this disclosure.

FIG. 3 is a diagram of a visual-field coordinate system set to an HMD according to at least one embodiment of this disclosure.

FIG. 4 is a diagram of an outline of a virtual space provided to a user according to at least one embodiment of this disclosure.

FIG. 5A and FIG. 5B are diagrams of cross sections of a field-of-view region according to at least one embodiment of this disclosure.

FIG. 6 is a diagram of a method of determining a line-of-sight direction of the user according to at least one embodiment of this disclosure.

FIG. 7 is a diagram of a configuration of a right controller according to at least one embodiment of this disclosure.

FIG. 8 is a block diagram if a functional configuration of the control circuit unit according to at least one embodiment of this disclosure.

FIG. 9 is a sequence diagram of a flow of processing of the HMD system providing the virtual space to the user according to at least one embodiment of this disclosure.

FIG. 10 is a sequence diagram of a flow of input processing in the virtual space according to at least one embodiment of this disclosure.

FIG. 11 is a sequence diagram of an exemplary flow of the input processing according to at least one embodiment of this disclosure.

FIG. 12 is a sequence diagram of an exemplary flow of the input processing according to at least one embodiment of this disclosure.

FIG. 13 is a diagram of exemplary input processing A according to at least one embodiment of this disclosure.

FIG. 14 is a diagram of exemplary input processing B according to at least one embodiment of this disclosure.

FIG. 15 is a diagram of the exemplary input processing B according to at least one embodiment of this disclosure.

FIG. 16 is a diagram of the exemplary input processing B according to at least one embodiment of this disclosure.

FIG. 17 is a diagram of exemplary input processing C according to at least one embodiment of this disclosure.

FIG. 18 is a diagram of the exemplary input processing C according to at least one embodiment of this disclosure.

FIG. 19 is a diagram of the exemplary input processing C according to at least one embodiment of this disclosure.

FIG. 20 is a block diagram of a functional configuration of the control circuit unit according to at least one embodiment of this disclosure.

FIG. 21 is a sequence diagram for illustrating progress of a selection operation in the virtual space.

FIG. 22 is a diagram of an example of transition of field-of-view images displayed on a display according to at least one embodiment of this disclosure.

FIG. 23 is a block diagram of a functional configuration of the control circuit unit according to at least one embodiment of this disclosure.

FIG. 24 is a flow chart of a flow of processing in an exemplary control method to be performed by the HMD system according to at least one embodiment of this disclosure.

FIG. 25 is a diagram of an example of arrangement of virtual objects exhibited when a user object is not attacked in a blind spot according to at least one embodiment of this disclosure.

FIG. 26 is a diagram of an example of the field-of-view image generated based on the arrangement of FIG. 25 according to at least one embodiment of this disclosure.

FIG. 27 is a diagram of an example of arrangement of virtual objects exhibited when the user object is attacked from a certain direction in the blind spot according to at least one embodiment of this disclosure.

FIG. 28 is a diagram of an example of the field-of-view image generated based on the arrangement of FIG. 27 according to at least one embodiment of this disclosure.

FIG. 29 is a diagram of an example of arrangement of virtual objects exhibited when the user object is attacked from another direction in the blind spot according to at least one embodiment of this disclosure.

FIG. 30 is a diagram of an example of the field-of-view image generated based on the arrangement of FIG. 29 according to at least one embodiment of this disclosure.

FIG. 31 is a diagram of an example of arrangement of virtual objects exhibited when the user object is attacked from still another direction in the blind spot according to at least one embodiment of this disclosure.

FIG. 32 is a diagram of an example of the field-of-view image generated based on the arrangement of FIG. 31 according to at least one embodiment of this disclosure.

FIG. 33 is a diagram of an example of a UI object according to at least one embodiment of this disclosure.

### DETAILED DESCRIPTION

Specific examples of a method of providing a virtual space and a system therefor according to at least one embodiment of this disclosure are described below with reference to the drawings. This disclosure is not limited to the examples described below, and is defined by the appended claims. It is intended that this disclosure includes all modifications within the appended claims and the equivalents thereof. In the following description, like elements are denoted by like reference symbols in the description of the drawings, and redundant description thereof is not repeated.

(Configuration of HMD System 100)

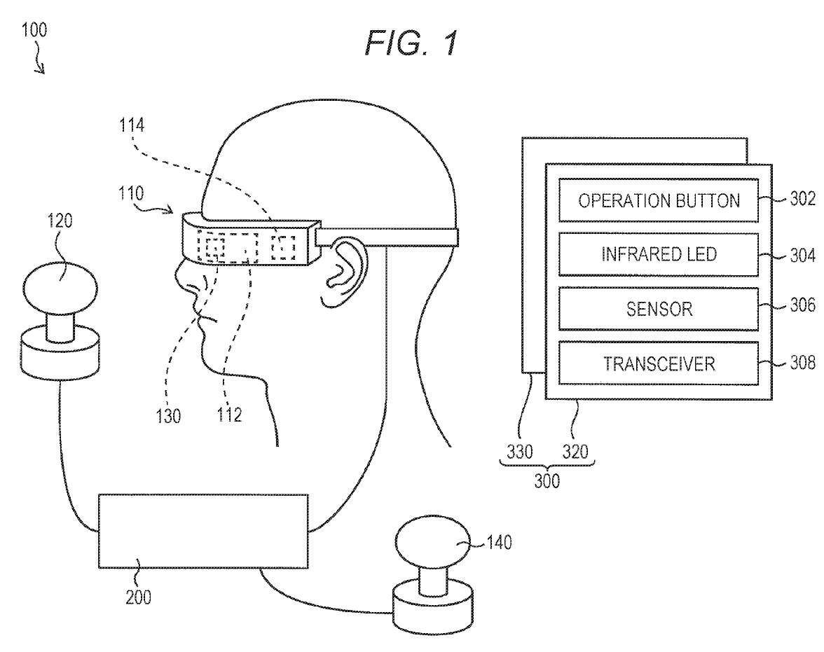

FIG. 1 is a diagram of a configuration of an HMD system 100 according to at least one embodiment of this disclosure. In FIG. 1, the HMD system 100 includes an HMD 110, an HMD sensor 120, a controller sensor 140, a control circuit unit 200, and a controller 300.

The HMD 110 is wearable on a head of a user. The HMD 110 includes a display 112 that is a non-transmissive (or partially transmissive) display device, a sensor 114, and an eye gaze sensor 130. The HMD 110 is configured to cause the display 112 to display each of a right-eye image and a left-eye image, to thereby enable the user to visually recognize a three-dimensional image to be three-dimensionally visually recognized by the user based on binocular parallax of both eyes of the user. A virtual space is provided to the user in this way. The display 112 is arranged right in front of the user's eyes, and hence the user can be immersed in the virtual space via an image displayed on the display 112. With this, the user can experience a virtual reality (VR). The virtual space may include a background, various objects that can be operated by the user, menu images, and the like.

The display 112 may include a right-eye sub-display configured to display a right-eye image, and a left-eye sub-display configured to display a left-eye image. Alternatively, the display 112 may be constructed of one display device configured to display the right-eye image and the left-eye image on a common screen. Examples of such a display device include a display device configured to switch at high speed a shutter that enables recognition of a display image with only one eye, to thereby independently and alternately display the right-eye image and the left-eye image.

Further, in at least one embodiment, a transmissive display may be used as the HMD 110. In other words, the HMD 110 may be a transmissive HMD. In this case, a virtual object described later can be arranged virtually in the real space by displaying a three-dimensional image on the transmissive display. With this, the user can experience a mixed reality (MR) in which the virtual object is arranged in the real space. In at least one embodiment, virtual experiences such as a virtual reality and a mixed reality for enabling the user to interact with the virtual object may be referred to as a “virtual experience”. In the following, a method of providing a virtual reality is described in detail as an example.

(Hardware Configuration of Control Circuit Unit 200)

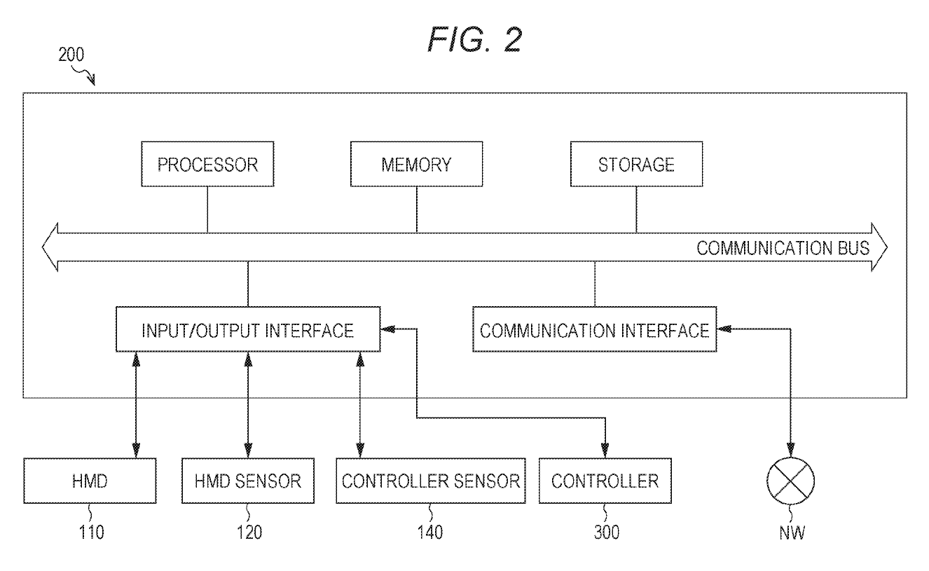

FIG. 2 is a diagram of a hardware configuration of the control circuit unit 200 according to at least one embodiment of this disclosure. The control circuit unit 200 is a computer for causing the HMD 110 to provide a virtual space. In FIG. 2, the control circuit unit 200 includes a processor, a memory, a storage, an input/output interface, and a communication interface. Those components are connected to each other in the control circuit unit 200 via a bus serving as a data transmission path.

The processor includes a central processing unit (CPU), a micro-processing unit (MPU), a graphics processing unit (GPU), or the like, and is configured to control the operation of the entire control circuit unit 200 and HMD system 100.

The memory functions as a main storage. The memory stores programs to be processed by the processor and control data (for example, calculation parameters). The memory may include a read only memory (ROM), a random access memory (RAM), or the like.

The storage functions as an auxiliary storage. The storage stores programs for controlling the operation of the entire HMD system 100, various simulation programs and user authentication programs, and various kinds of data (for example, images and objects) for defining the virtual space. Further, a database including tables for managing various kinds of data may be constructed in the storage. The storage may include a flash memory, a hard disk drive (HDD), or the like.

The input/output interface includes various wire connection terminals such as a universal serial bus (USB) terminal, a digital visual interface (DVI) terminal, and a high-definition multimedia interface (HDMI) (R) terminal, and various processing circuits for wireless connection. The input/output interface is configured to connect the HMD 110, various sensors including the HMD sensor 120 and the controller sensor 140, and the controller 300 to each other.

The communication interface includes various wire connection terminals for communicating to/from an external apparatus via a network NW, and various processing circuits for wireless connection. The communication interface is configured to adapt to various communication standards and protocols for communication via a local area network (LAN) or the Internet.

The control circuit unit 200 is configured to load a predetermined application program stored in the storage to the memory to execute the program, to thereby provide the virtual space to the user. At the time of execution of the program, the memory and the storage store various programs for operating various objects to be arranged in the virtual space, or for displaying and controlling various menu images and the like.

The control circuit unit 200 may be mounted on the HMD 110, or may not be mounted thereon. That is, the control circuit unit 200 may be constructed as different hardware independent of the HMD 110 (for example, a personal computer, or a server apparatus that can communicate to/from the HMD 110 via a network). The control circuit unit 200 may be a device having the form in which one or more functions are implemented through cooperation between a plurality of pieces of hardware. Alternatively, apart of hardware for executing the functions of the control circuit unit 200 may be mounted on the HMD 110, and a part of hardware for executing other functions thereof may be mounted on different hardware.

In each element, for example, the HMD 110, constructing the HMD system 100, a global coordinate system (reference coordinate system, xyz coordinate system) is set in advance. The global coordinate system has three reference directions (axes) that are respectively parallel to a vertical direction, a lateral direction orthogonal to the vertical direction, and a front-rear direction orthogonal to both of the vertical direction and the lateral direction in a real space. In at least one embodiment, the global coordinate system is one type of point-of-view coordinate system, and hence the lateral direction, the vertical direction (up-down direction), and the front-rear direction of the global coordinate system are referred to as an x axis, a y axis, and a z axis, respectively. Specifically, the x axis of the global coordinate system is parallel to the lateral direction of the real space, the y axis thereof is parallel to the vertical direction of the real space, and the z axis thereof is parallel to the front-rear direction of the real space.

The HMD sensor 120 has a position tracking function for detecting the movement of the HMD 110. The HMD sensor 120 is configured to detect the position and the inclination of the HMD 110 in the real space with this function. In order to enable this detection, the HMD 110 includes a plurality of light sources (not shown). Each of the light sources is, for example, an LED configured to emit an infrared ray. The HMD sensor 120 includes, for example, an infrared sensor. The HMD sensor 120 detects the infrared ray emitted from the light source of the HMD 110 by the infrared sensor, to thereby detect a detection point of the HMD 110. Further, based on a detection value of the detection point of the HMD 110, the HMD sensor 120 detects the position and the inclination of the HMD 110 in the real space based on the movement of the user. The HMD sensor 120 can determine a time change of the position and the inclination of the HMD 110 based on a temporal change of the detection value.

The HMD sensor 120 may include an optical camera. In this case, the HMD sensor 120 detects the position and the inclination of the HMD 110 based on image information of the HMD 110 obtained by the optical camera.

The HMD 110 may use the sensor 114 instead of the HMD sensor 120 to detect the position and the inclination of the HMD 110. In this case, the sensor 114 may be, for example, an angular velocity sensor, a geomagnetic sensor, an acceleration sensor, or a gyrosensor. The HMD 110 uses at least one of those sensors. When the sensor 114 is the angular velocity sensor, the sensor 114 detects over time the angular velocity about three axes in the real space of the HMD 110 in accordance with the movement of the HMD 110. The HMD 110 can determine the time change of the angle about the three axes of the HMD 110 based on the detection value of the angular velocity, and can detect the inclination of the HMD 110 based on the time change of the angle.

When the HMD 110 itself detects the position and the inclination of the HMD 110 based on the detection value of the sensor 114, the HMD system 100 does not require the HMD sensor 120. In at least one embodiment, when the HMD sensor 120 arranged at a position away from the HMD 110 detects the position and the inclination of the HMD 110, the HMD 110 does not include the sensor 114.

As described above, the global coordinate system is parallel to the coordinate system of the real space. Therefore, each inclination of the HMD 110 detected by the HMD sensor 120 corresponds to each inclination about the three axes of the HMD 110 in the global coordinate system. The HMD sensor 120 sets a uvw visual-field coordinate system to the HMD 110 based on the detection value of the inclination of the HMD sensor 120 in the global coordinate system. The uvw visual-field coordinate system set in the HMD 110 corresponds to the point-of-view coordinate system used when the user wearing the HMD 110 views an object.

(Uvw Visual-Field Coordinate System)

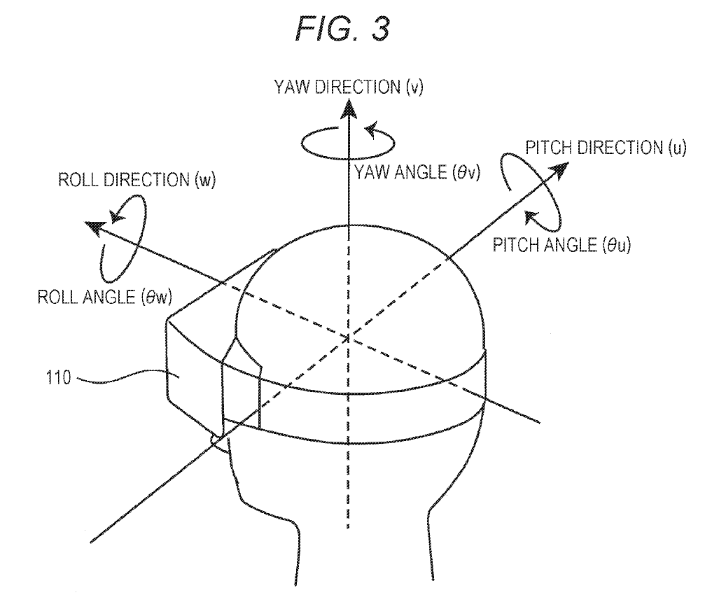

FIG. 3 is a diagram of the uvw visual-field coordinate system to be set in the HMD 110 according to at least one embodiment of this disclosure. The HMD sensor 120 detects the position and the inclination of the HMD 110 in the global coordinate system when the HMD 110 is activated. Then, a three-dimensional uvw visual-field coordinate system based on the detection value of the inclination is set to the HMD 110. In FIG. 3, the HMD sensor 120 sets, to the HMD 110, a three-dimensional uvw visual-field coordinate system defining the head of the user wearing the HMD 110 as a center (origin). Specifically, new three directions obtained by inclining the lateral direction, the vertical direction, and the front-rear direction (x axis, y axis, and z axis), which define the global coordinate system, about the respective axes by the inclinations about the respective axes of the HMD 110 in the global coordinate system are set as a pitch direction (u axis), a yaw direction (v axis), and a roll direction (w axis) of the uvw visual-field coordinate system in the HMD 110, respectively.

In FIG. 3, when the user wearing the HMD 110 is standing upright and is visually recognizing the front side, the HMD sensor 120 sets the uvw visual-field coordinate system that is parallel to the global coordinate system to the HMD 110. In this case, the lateral direction (x axis), the vertical direction (y axis), and the front-rear direction (z axis) of the global coordinate system directly match the pitch direction (u axis), the yaw direction (v axis), and the roll direction (w axis) of the uvw visual-field coordinate system in the HMD 110, respectively.

After the uvw visual-field coordinate system is set to the HMD 110, the HMD sensor 120 can detect the inclination (change amount of the inclination) of the HMD 110 in the uvw visual-field coordinate system that is currently set based on the movement of the HMD 110. In this case, the HMD sensor 120 detects, as the inclination of the HMD 110, each of a pitch angle (θu), a yaw angle (θv), and a roll angle (θw) of the HMD 110 in the uvw visual-field coordinate system that is currently set. The pitch angle (θu) is an inclination angle of the HMD 110 about the pitch direction in the uvw visual-field coordinate system. The yaw angle (θv) is an inclination angle of the HMD 110 about the yaw direction in the uvw visual-field coordinate system. The roll angle (θw) is an inclination angle of the HMD 110 about the roll direction in the uvw visual-field coordinate system.

The HMD sensor 120 newly sets, based on the detection value of the inclination of the HMD 110, the uvw visual-field coordinate system of the HMD 110 obtained after the movement to the HMD 110. The relationship between the HMD 110 and the uvw visual-field coordinate system of the HMD 110 is always constant regardless of the position and the inclination of the HMD 110. When the position and the inclination of the HMD 110 change, the position and the inclination of the uvw visual-field coordinate system of the HMD 110 in the global coordinate system similarly change in synchronization therewith.

The HMD sensor 120 may identify the position of the HMD 110 in the real space as a position relative to the HMD sensor 120 based on the light intensity of the infrared ray or a relative positional relationship between a plurality of detection points (for example, a distance between the detection points), which is acquired by the infrared sensor. Further, the origin of the uvw visual-field coordinate system of the HMD 110 in the real space (global coordinate system) may be determined based on the identified relative position. Further, the HMD sensor 120 may detect the inclination of the HMD 110 in the real space based on the relative positional relationship between the plurality of detection points, and further determine the direction of the uvw visual-field coordinate system of the HMD 110 in the real space (global coordinate system) based on the detection value of the inclination.

(Overview of Virtual Space 2)

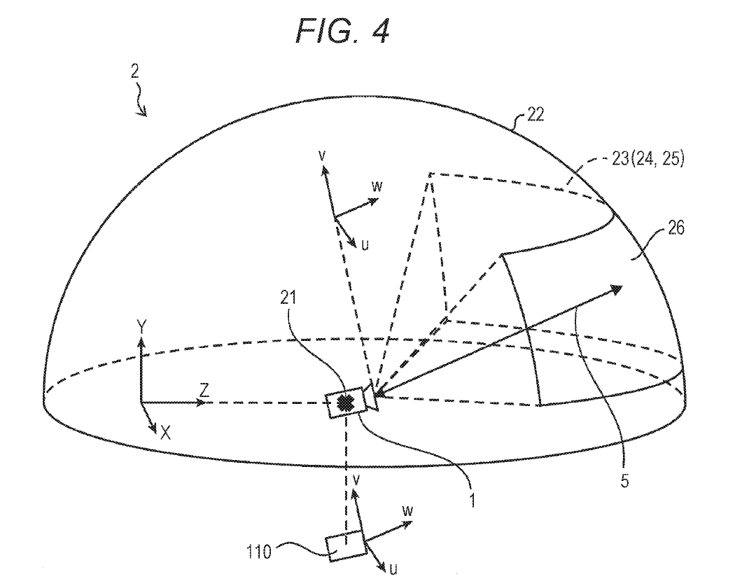

FIG. 4 is a diagram of an overview of a virtual space 2 to be provided to the user according to at least one embodiment of this disclosure. In FIG. 4, the virtual space 2 has a structure with an entire celestial sphere shape covering a center 21 in all 360-degree directions. In FIG. 4, only the upper-half celestial sphere of the entire virtual space 2 is shown for the sake of clarity. A plurality of substantially-square or substantially-rectangular mesh sections are associated with the virtual space 2. The position of each mesh section in the virtual space 2 is defined in advance as coordinates in a spatial coordinate system (XYZ coordinate system) defined in the virtual space 2. The control circuit unit 200 associates each partial image forming content (for example, still image or moving image) that can be developed in the virtual space 2 with each corresponding mesh section in the virtual space 2, to thereby provide, to the user, the virtual space 2 in which a virtual space image 22 that can be visually recognized by the user is developed.

In the virtual space 2, an XYZ spatial coordinate system having the center 21 as the origin is defined. The XYZ coordinate system is, for example, parallel to the global coordinate system. The XYZ coordinate system is one type of the point-of-view coordinate system, and hence the lateral direction, the vertical direction (up-down direction), and the front-rear direction of the XYZ coordinate system are referred to as an X axis, a Y axis, and a Z axis, respectively. That is, the X axis (lateral direction) of the XYZ coordinate system is parallel to the x axis of the global coordinate system, the Y axis (up-down direction) of the XYZ coordinate system is parallel to the y axis of the global coordinate system, and the Z axis (front-rear direction) of the XYZ coordinate system is parallel to the z axis of the global coordinate system.

When the HMD 110 is activated (in an initial state), a virtual camera 1 is arranged at the center 21 of the virtual space 2. In synchronization with the movement of the HMD 110 in the real space, the virtual camera 1 similarly moves in the virtual space 2. With this, the change in position and direction of the HMD 110 in the real space is reproduced similarly in the virtual space 2.

The uvw visual-field coordinate system is defined in the virtual camera 1 similarly to the HMD 110. The uvw visual-field coordinate system of the virtual camera 1 in the virtual space 2 is defined so as to be synchronized with the uvw visual-field coordinate system of the HMD 110 in the real space (global coordinate system). Therefore, when the inclination of the HMD 110 changes, the inclination of the virtual camera 1 also changes in synchronization therewith. The virtual camera 1 can also move in the virtual space 2 in synchronization with the movement of the user wearing the HMD 110 in the real space.

The direction of the virtual camera 1 in the virtual space 2 is determined based on the position and the inclination of the virtual camera 1 in the virtual space 2. With this, a line of sight (reference line of sight 5) serving as a reference when the user visually recognizes the virtual space image 22 developed in the virtual space 2 is determined. The control circuit unit 200 determines a field-of-view region 23 in the virtual space 2 based on the reference line of sight 5. The field-of-view region 23 is a region corresponding to a field of view of the user wearing the HMD 110 in the virtual space 2.

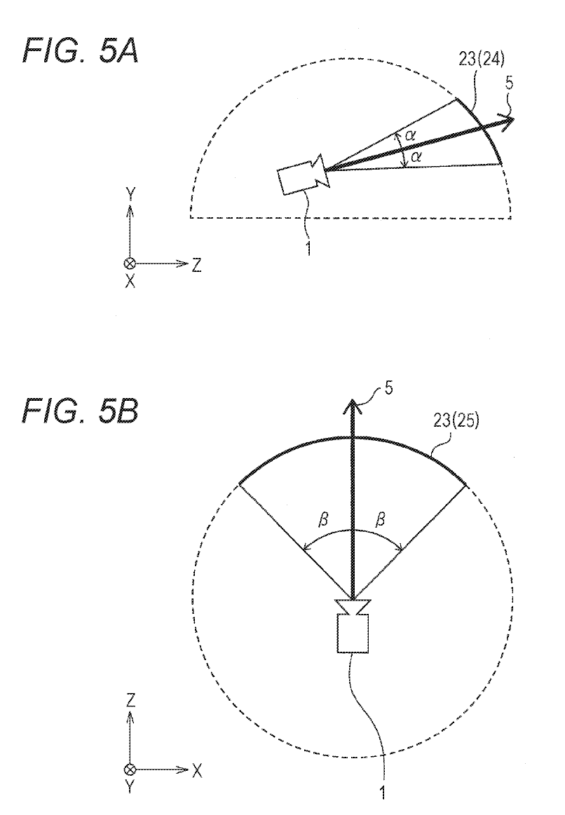

FIG. 5A and FIG. 5B are diagrams of cross sections of the field-of-view region 23 according to at least one embodiment of this disclosure. FIG. 5A is a YZ cross section of the field-of-view region 23 as viewed from an X direction in the virtual space 2 according to at least one embodiment of this disclosure. FIG. 5B is an XZ cross section of the field-of-view region 23 as viewed from a Y direction in the virtual space 2 according to at least one embodiment of this disclosure. The field-of-view region 23 has a first region 24 (see FIG. 5A) that is a range defined by the reference line of sight 5 and the YZ cross section of the virtual space 2, and a second region 25 (see FIG. 5B) that is a range defined by the reference line of sight 5 and the XZ cross section of the virtual space 2. The control circuit unit 200 sets, as the first region 24, a range of a polar angle α from the reference line of sight 5 serving as the center in the virtual space 2. Further, the control circuit unit 200 sets, as the second region 25, a range of an azimuth β from the reference line of sight 5 serving as the center in the virtual space 2.

The HMD system 100 provides the virtual space 2 to the user by displaying a field-of-view image 26, which is a part of the virtual space image 22 to be superimposed with the field-of-view region 23, on the display 112 of the HMD 110. When the user moves the HMD 110, the virtual camera 1 also moves in synchronization therewith. As a result, the position of the field-of-view region 23 in the virtual space 2 changes. In this manner, the field-of-view image 26 displayed on the display 112 is updated to an image that is superimposed with a portion (field-of-view region 23) of the virtual space image 22 to which the user faces in the virtual space 2. Therefore, the user can visually recognize a desired portion of the virtual space 2.

The user cannot see the real world while wearing the HMD 110, and visually recognizes only the virtual space image 22 developed in the virtual space 2. Therefore, the HMD system 100 can provide a high sense of immersion in the virtual space 2 to the user.

The control circuit unit 200 may move the virtual camera 1 in the virtual space 2 in synchronization with the movement of the user wearing the HMD 110 in the real space. In this case, the control circuit unit 200 identifies the field-of-view region 23 to be visually recognized by the user by being projected on the display 112 of the HMD 110 in the virtual space 2 based on the position and the direction of the virtual camera 1 in the virtual space 2.

In at least one embodiment, the virtual camera 1 includes a right-eye virtual camera configured to provide a right-eye image and a left-eye virtual camera configured to provide a left-eye image. Further, in at least one embodiment, an appropriate parallax is set for the two virtual cameras so that the user can recognize the three-dimensional virtual space 2. In at least one embodiment, as a representative of those virtual cameras, only such a virtual camera 1 that the roll direction (w) generated by combining the roll directions of the two virtual cameras is adapted to the roll direction (w) of the HMD 110 is illustrated and described.

(Detection of Line-of-Sight Direction)

The eye gaze sensor 130 has an eye tracking function of detecting directions (line-of-sight directions) in which the user's right and left eyes are directed. As the eye gaze sensor 130, a known sensor having the eye tracking function can be employed. In at least one embodiment, the eye gaze sensor 130 includes a right-eye sensor and a left-eye sensor. For example, the eye gaze sensor 130 may be a sensor configured to irradiate each of the right eye and the left eye of the user with infrared light to receive reflection light from the cornea and the iris with respect to the irradiation light, to thereby detect a rotational angle of each eyeball. The eye gaze sensor 130 can detect the line-of-sight direction of the user based on each detected rotational angle.

The line-of-sight direction of the user detected by the eye gaze sensor 130 is a direction in the point-of-view coordinate system obtained when the user visually recognizes an object. As described above, the uvw visual-field coordinate system of the HMD 110 is equal to the point-of-view coordinate system used when the user visually recognizes the display 112. Further, the uvw visual-field coordinate system of the virtual camera 1 is synchronized with the uvw visual-field coordinate system of the HMD 110. Therefore, in the HMD system 100, the user's line-of-sight direction detected by the eye gaze sensor 130 can be regarded as the user's line-of-sight direction in the uvw visual-field coordinate system of the virtual camera 1.

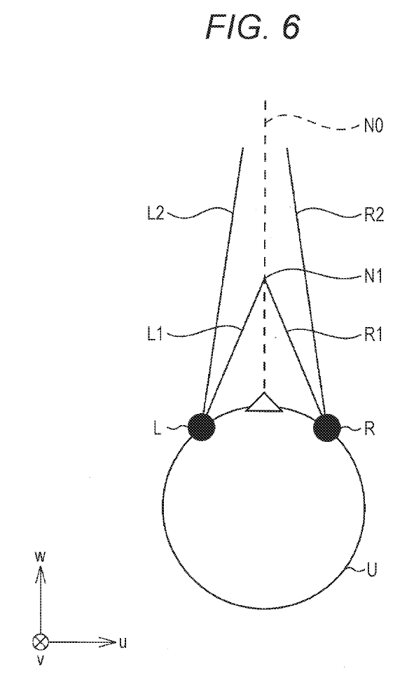

FIG. 6 is a diagram of a method of determining the line-of-sight direction of the user according to at least one embodiment of this disclosure. In FIG. 6, the eye gaze sensor 130 detects lines of sight of a right eye and a left eye of a user U. When the user U is looking at a near place, the eye gaze sensor 130 detects lines of sight R1 and L1 of the user U. When the user is looking at a far place, the eye gaze sensor 130 identifies lines of sight R2 and L2, which form smaller angles with respect to the roll direction (w) of the HMD 110 as compared to the lines of sight R1 and L1 of the user. The eye gaze sensor 130 transmits the detection values to the control circuit unit 200.

When the control circuit unit 200 receives the lines of sight R1 and L1 as the detection values of the lines of sight, the control circuit unit 200 identifies a point of gaze N1 being an intersection of both the lines of sight R1 and L1. Further, even when the control circuit unit 200 receives the lines of sight R2 and L2, the control circuit unit 200 identifies a point of gaze N2 (not shown) being an intersection of both the lines of sight R2 and L2. The control circuit unit 200 detects a line-of-sight direction NO of the user U based on the identified point of gaze N1. The control circuit unit 200 detects, for example, an extension direction of a straight line that passes through the point of gaze N1 and a midpoint of a straight line connecting a right eye R and a left eye L of the user U to each other as the line-of-sight direction NO. The line-of-sight direction NO is a direction in which the user U actually directs his or her lines of sight with both eyes. The line-of-sight direction NO is also a direction in which the user U actually directs his or her lines of sight with respect to the field-of-view region 23.

The HMD system 100 may include microphones and speakers in any element constructing the HMD system 100. With this, the user can issue an instruction with sound to the virtual space 2. Further, the HMD system 100 may include a television receiver in any element in order to receive broadcast of a television program in a virtual television in the virtual space. Further, the HMD system 100 may have a communication function or the like in order to display an electronic mail or the like sent to the user.

(Controller 300)

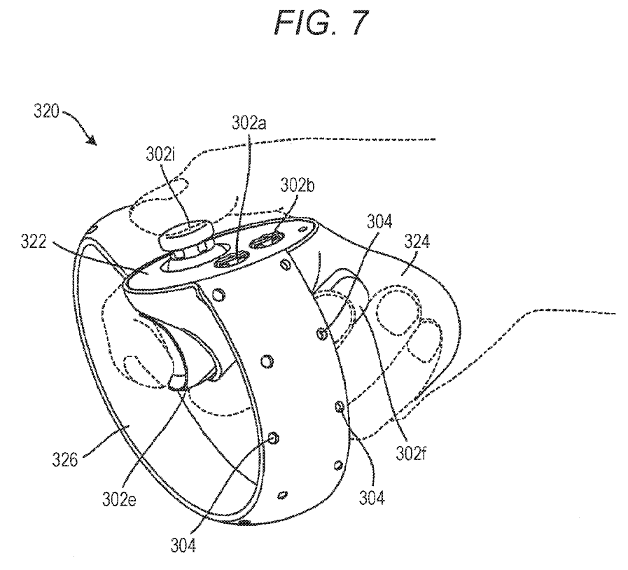

FIG. 7 is a diagram of a configuration of the controller 300 according to at least one embodiment of this disclosure. The controller 300 is an example of a device to be used for controlling movement of the virtual object by detecting movement of a part of the body of the user. In FIG. 1, the controller 300 is formed of a right controller 320 to be used by the user with the right hand and a left controller 330 to be used by the user with the left hand. The right controller 320 and the left controller 330 are separate devices. The user can freely move the right hand holding the right controller 320 and the left hand holding the left controller 330 independently of each other. The method of detecting movement of a part of the body of the user other than the head is not limited to the example of using a controller including a sensor mounted to the part of the body, but an image recognition technique and other any physical and optical techniques can be used. For example, an external camera can be used to identify the initial position of the part of the body of the user and the position of the part of the body of the user continuously, to thereby detect movement of the part of the body of the user other than the head. In the following description, detection of movement of a part of the body of the user other than the head using the controller 300 is described in detail.

In FIG. 1, the right controller 320 and the left controller 330 each include operation buttons 302, infrared light emitting diodes (LEDs) 304, a sensor 306, and a transceiver 308. The right controller 320 and the left controller 330 may include only one of the infrared LEDs 304 and the sensor 306. In the following description, the right controller 320 and the left controller 330 have a common configuration, and thus only the configuration of the right controller 320 is described.

The controller sensor 140 has a position tracking function for detecting movement of the right controller 320. The controller sensor 140 detects the positions and inclinations of the right controller 320 in the real space. The controller sensor 140 detects each of the infrared lights emitted by the infrared LEDs 304 of the right controller 320. The controller sensor 140 includes an infrared camera configured to photograph an image in an infrared wavelength region, and detects positions and inclinations of the right controller 320 based on data on an image photographed by this infrared camera.

The right controller 320 may detect the positions and inclinations of itself using the sensor 306 instead of the controller sensor 140. In this case, for example, a three-axis angular velocity sensor (sensor 306) of the right controller 320 detects rotation of the right controller 320 about three orthogonal axes. The right controller 320 detects how much and in which direction the right controller 320 has rotated based on the detection values, and calculates the inclination of the right controller 320 by integrating the sequentially detected rotation direction and rotation amount. The right controller 320 may use the detection values of a three-axis magnetic sensor and/or a three-axis acceleration sensor in addition to the detection values of the three-axis angular velocity sensor.

The operation buttons 302 are a group of a plurality of buttons configured to receive input of an operation on the controller 300 by the user. In at least one embodiment, the operation buttons 302 include a push button, a trigger button, and an analog stick.

The push button is a button configured to be operated by an operation of pushing the button down with the thumb. The right controller 320 includes thumb buttons 302a and 302b on a top surface 322 as push buttons. The thumb buttons 302a and 302b are each operated (pushed) by the right thumb. The state of the thumb of the virtual right hand being extended is changed to the state of the thumb being bent by the user pressing the thumb buttons 302a and 302b with the thumb of the right hand or placing the thumb on the top surface 322.

The trigger button is a button configured to be operated by movement of pulling the trigger of the trigger button with the index finger or the middle finger. The right controller 320 includes an index finger button 302e on the front surface of a grip 324 as a trigger button. The state of the index finger of the virtual right hand being extended is changed to the state of the index finger being bent by the user bending the index finger of the right hand and operating the index finger button 302e. The right controller 320 further includes a middle finger button 302f on the side surface of the grip 324. The state of the middle finger, a ring finger, and a little finger of the virtual right hand being extended is changed to the state of the middle finger, the ring finger, and the little finger being bent by the user operating the middle finger button 302f with the middle finger of the right hand.

The right controller 320 is configured to detect push states of the thumb buttons 302a and 302b, the index finger button 302e, and the middle finger button 302f, and to output those detection values to the control circuit unit 200.

In at least one embodiment, the detection values of push states of respective buttons of the right controller 320 may take any one of values of from 0 to 1. For example, when the user does not push the thumb button 302a at all, “0” is detected as the push state of the thumb button 302a. On the other hand, when the user pushes the thumb button 302a completely (most deeply), “1” is detected as the push state of the thumb button 302a. The bent degree of each finger of the virtual hand may be adjusted with this setting. For example, the state of the finger being extended is defined to be “0” and the state of the finger being bent is defined to be “1”, to thereby enable the user to control the finger of the virtual hand with an intuitive operation.

The analog stick is a stick button capable of being tilted by any direction within 360° from a predetermined neutral position. An analog stick 302i is arranged on the top surface 322 of the right controller 320. The analog stick 302i is operated with the thumb of the right hand.

The right controller 320 includes a frame 326 forming a semicircular ring extending from both side surfaces of the grip 324 in a direction opposite to the top surface 322. The plurality of infrared LEDs 304 are embedded into an outer surface of the frame 326.

The infrared LED 304 is configured to emit infrared light during reproduction of content by HMD system 100. The infrared light emitted by the infrared LED 304 is used to detect the position and inclination of the right controller 320.

The right controller 320 further incorporates the sensor 306 instead of the infrared LEDs 304 or in addition to the infrared LEDs 304. The sensor 306 may be any one of, for example, a magnetic sensor, an angular velocity sensor, or an acceleration sensor, or a combination of those sensors. The positions and inclinations of the right controller 320 can be detected by the sensor 306.

The transceiver 308 is configured to enable transmission or reception of data between the right controller 320 and the control circuit unit 200. The transceiver 308 transmits, to the control circuit unit 200, data that is based on input of an operation of the right controller 320 by the user using the operation button 302. Further, the transceiver 308 receives, from the control circuit unit 200, a command for instructing the right controller 320 to cause the infrared LEDs 304 to emit light. Further, the transceiver 308 transmits data on various kinds of values detected by the sensor 306 to the control circuit unit 200.

The right controller 320 may include a vibrator for transmitting haptic feedback to the hand of the user through vibration. In this configuration, the transceiver 308 can receive, from the control circuit unit 200, a command for causing the vibrator to transmit haptic feedback in addition to transmission or reception of each piece of data described above.

(Functional Configuration of Control Circuit Unit 200)

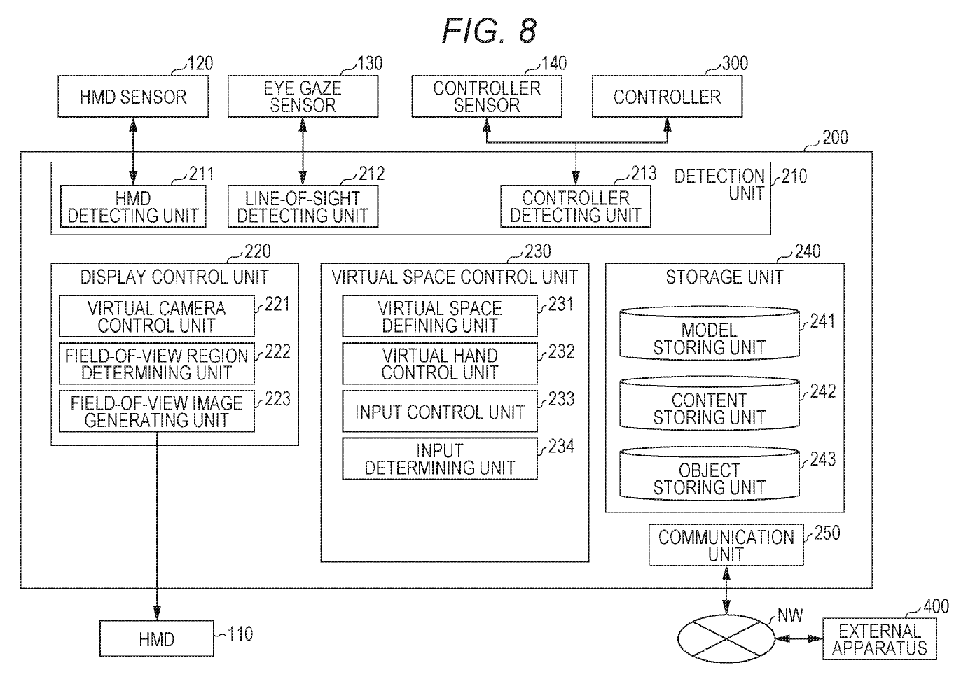

FIG. 8 is a block diagram of the functional configuration of the control circuit unit 200 according to at least one embodiment of this disclosure. The control circuit unit 200 is configured to use various types of data received from the HMD sensor 120, the controller sensor 140, the eye gaze sensor 130, and the controller 300 to control the virtual space 2 to be provided to the user. Further, the control circuit unit 200 is configured to control the image display on the display 112 of the HMD 110. In FIG. 8, the control circuit unit 200 includes a detection unit 210, a display control unit 220, a virtual space control unit 230, a storage unit 240, and a communication unit 250. The control circuit unit 200 functions as the detection unit 210, the display control unit 220, the virtual space control unit 230, the storage unit 240, and the communication unit 250 through cooperation between each piece of hardware illustrated in FIG. 2. The detection unit 210, the display control unit 220, and the virtual space control unit 230 may implement their functions mainly through cooperation between the processor and the memory. The storage unit 240 may implement functions through cooperation between the memory and the storage. The communication unit 250 may implement functions through cooperation between the processor and the communication interface.

The detection unit 210 is configured to receive the detection values from various sensors (for example, the HMD sensor 120) connected to the control circuit unit 200. Further, the detection unit 210 is configured to execute predetermined processing using the received detection values as necessary. The detection unit 210 includes an HMD detecting unit 211, a line-of-sight detecting unit 212, and a controller detection unit 213. The HMD detecting unit 211 is configured to receive a detection value from each of the HMD 110 and the HMD sensor 120. The line-of-sight detecting unit 212 is configured to receive a detection value from the eye gaze sensor 130. The controller detection unit 213 is configured to receive the detection values from the controller sensor 104, the right controller 320, and the left controller 330.

The display control unit 220 is configured to control the image display on the display 112 of the HMD 110. The display control unit 220 includes a virtual camera control unit 221, a field-of-view region determining unit 222, and a field-of-view image generating unit 223. The virtual camera control unit 221 is configured to arrange the virtual camera 1 in the virtual space 2. The virtual camera control unit 221 is also configured to control the behavior of the virtual camera 1 in the virtual space 2. The field-of-view region determining unit 222 is configured to determine the field-of-view region 23. The field-of-view image generating unit 223 is configured to generate the field-of-view image 26 to be displayed on the display 112 based on the determined field-of-view region 23.

The virtual space control unit 230 is configured to control the virtual space 2 to be provided to the user. The virtual space control unit 230 includes a virtual space defining unit 231, a virtual hand control unit 232, an input control unit 233, and an input determining unit 234.

The virtual space defining unit 231 is configured to generate virtual space data representing the virtual space 2 to be provided to the user, to thereby define the virtual space 2 in the HMD system 100. The virtual hand control unit 232 is configured to arrange each virtual hand (virtual right hand and virtual left hand) of the user in the virtual space 2 depending on operations of the right controller 320 and the left controller 330 by the user. The virtual hand control unit 232 is also configured to control behavior of each virtual hand in the virtual space 2. The input control unit 233 is configured to arrange an input object, which is a virtual object to be used for input, in the virtual space 2. Input details are associated with the input object. The input control unit 233 is also configured to arrange a determination object, which is a virtual object to be used for determination of input, in the virtual space 2. The input determining unit 234 is configured to determine input details based on a positional relationship between the input object and the determination object.

The storage unit 240 stores various types of data to be used by the control circuit unit 200 to provide the virtual space 2 to the user. The storage unit 240 includes a model storing unit 241, a content storing unit 242, and an object storing unit 243. The model storing unit 241 stores various types of model data representing the model of the virtual space 2. The content storing unit 242 stores various types of content that can be reproduced in the virtual space 2. The object storing unit 243 stores an input object and a determination object to be used for input.

The model data includes spatial structure data that defines the spatial structure of the virtual space 2. The spatial structure data is data that defines, for example, the spatial structure of the entire celestial sphere of 360° about the center 21. The model data further includes data that defines the XYZ coordinate system of the virtual space 2. The model data further includes coordinate data that identifies the position of each mesh section forming the celestial sphere in the XYZ coordinate system. The model data further includes a flag for representing whether or not the virtual object can be arranged in the virtual space 2.

The content is content that can be reproduced in the virtual space 2. In at least one embodiment, the content is game content. The content contains at least a background image of the game and data for defining virtual objects (e.g., character and item) appearing in the game. Each piece of content has a preliminarily defined initial direction toward an image to be presented to the user under the initial state (at the activation) of the HMD 110.

The communication unit 250 is configured to transmit or receive data to or from an external apparatus 400 (for example, a game server) via the network NW.

(Processing of Providing Virtual Space 2)

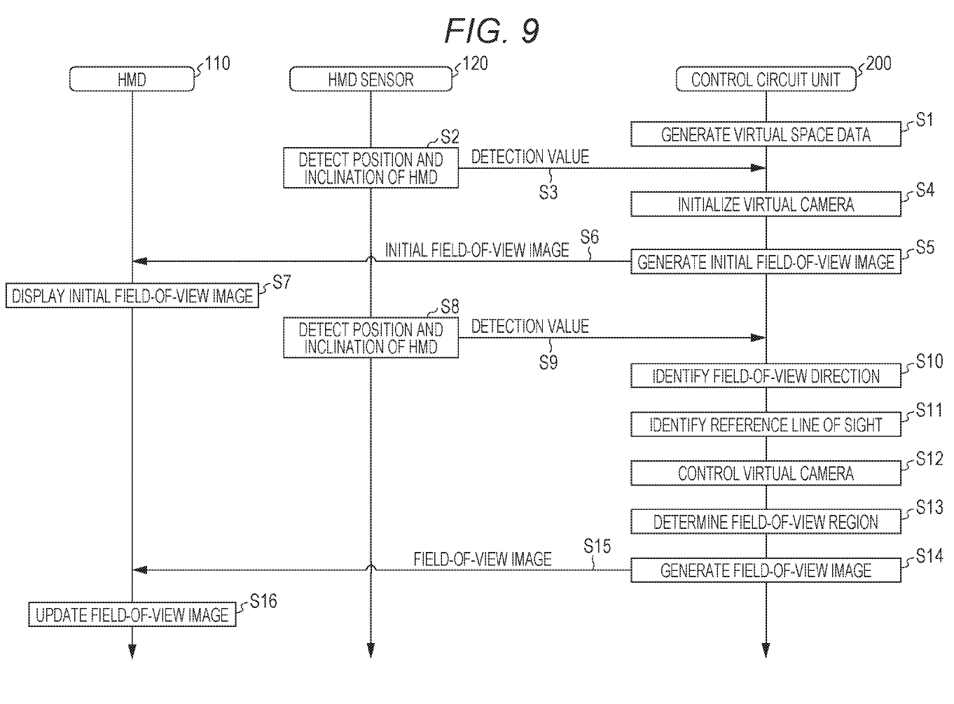

FIG. 9 is a sequence diagram of a flow of processing performed by the HMD system 100 to provide the virtual space 2 to the user according to at least one embodiment of this disclosure. The virtual space 2 is basically provided to the user through cooperation between the HMD 110 and the control circuit unit 200. When the processing in FIG. 9 is executed, in Step S1, the virtual space defining unit 231 generates virtual space data representing the virtual space 2 to be provided to the user, to thereby define the virtual space 2. The procedure of the generation is as follows. First, the virtual space defining unit 231 acquires model data of the virtual space 2 from the model storing unit 241, to thereby define the original form of the virtual space 2. The virtual space defining unit 231 further acquires content to be reproduced in the virtual space 2 from the content storing unit 242. In at least one embodiment, the content may be game content.

The virtual space defining unit 231 adapts the acquired content to the acquired model data, to thereby generate the virtual space data that defines the virtual space 2. The virtual space defining unit 231 associates as appropriate each partial image forming the background image included in the content with management data of each mesh section forming the celestial sphere of the virtual space 2 in the virtual space data. In at least one embodiment, the virtual space defining unit 231 associates each partial image with each mesh section so that the initial direction defined for the content matches the Z direction in the XYZ coordinate system of the virtual space 2.

In at least one embodiment, the virtual space defining unit 231 further adds the management data of each virtual object included in the content to the virtual space data. At this time, coordinates representing the position at which the corresponding virtual object is arranged in the virtual space 2 are set to the management data. With this, each virtual object is arranged at a position of the coordinates in the virtual space 2.

After that, when the HMD 110 is activated by the user, in Step S2, the HMD sensor 120 detects the position and the inclination of the HMD 110 in the initial state. In Step S3, the HMD sensor 120 outputs the detection values to the control circuit unit 200. The HMD detecting unit 211 receives the detection values. After that, in Step S4, the virtual camera control unit 221 initializes the virtual camera 1 in the virtual space 2.

The procedure of the initialization is as follows. The virtual camera control unit 221 arranges the virtual camera 1 at the initial position in the virtual space 2 (for example, the center 21 in FIG. 4). Next, the direction of the virtual camera 1 in the virtual space 2 is set. At this time, the virtual camera control unit 221 may identify the uvw visual-field coordinate system of the HMD 110 in the initial state based on the detection values from the HMD sensor 120, and set, for the virtual camera 1, the uvw visual-field coordinate system that matches the uvw visual-field coordinate system of the HMD 110, to thereby set the direction of the virtual camera 1. When the virtual camera control unit 221 sets the uvw visual-field coordinate system for the virtual camera 1, the roll direction (w axis) of the virtual camera 1 is adapted to the Z direction (Z axis) of the XYZ coordinate system. Specifically, the virtual camera control unit 221 matches the direction obtained by projecting the roll direction of the virtual camera 1 on an XZ plane with the Z direction of the XYZ coordinate system, and matches the inclination of the roll direction of the virtual camera 1 with respect to the XZ plane with the inclination of the roll direction of the HMD 110 with respect to a horizontal plane. Such adaptation processing enables adaptation of the roll direction of the virtual camera 1 in the initial state to the initial direction of the content, and hence the horizontal direction in which the user first faces after the reproduction of the content is started can be matched with the initial direction of the content.

After the initialization processing of the virtual camera 1 is ended, the field-of-view region determining unit 222 determines the field-of-view region 23 in the virtual space 2 based on the uvw visual-field coordinate system of the virtual camera 1. Specifically, the roll direction (w axis) of the uvw visual-field coordinate system of the virtual camera 1 is identified as the reference line of sight 5 of the user, and the field-of-view region 23 is determined based on the reference line of sight 5. In Step S5, the field-of-view image generating unit 223 processes the virtual space data, to thereby generate (render) the field-of-view image 26 corresponding to the part of the entire virtual space image 22 developed in the virtual space 2 to be projected on the field-of-view region 23 in the virtual space 2. In Step S6, the field-of-view image generating unit 223 outputs the generated field-of-view image 26 as an initial field-of-view image to the HMD 110. In Step S7, the HMD 110 displays the received initial field-of-view image on the display 112. With this, the user visually recognizes the initial field-of-view image.

After that, in Step S8, the HMD sensor 120 detects the current position and inclination of the HMD 110, and in Step S9, outputs the detection values thereof to the control circuit unit 200. The HMD detecting unit 211 receives each detection value. The virtual camera control unit 221 identifies the current uvw visual-field coordinate system in the HMD 110 based on the detection values of the position and the inclination of the HMD 110. Further, in Step S10, the virtual camera control unit 221 identifies the roll direction (w axis) of the uvw visual-field coordinate system in the XYZ coordinate system as a field-of-view direction of the HMD 110.

In at least one embodiment, in Step S11, the virtual camera control unit 221 identifies the identified field-of-view direction of the HMD 110 as the reference line of sight 5 of the user in the virtual space 2. In Step S12, the virtual camera control unit 221 controls the virtual camera 1 based on the identified reference line of sight 5. The virtual camera control unit 221 maintains the position and the direction of the virtual camera 1 when the position (origin) and the direction of the reference line of sight 5 are the same as those in the initial state of the virtual camera 1. Meanwhile, when the position (origin) and/or the direction of the reference line of sight 5 are/is changed from those in the initial state of the virtual camera 1, the position and/or the inclination of the virtual camera 1 in the virtual space 2 are/is changed to the position and/or the inclination that are/is based on the reference line of sight 5 obtained after the change. Further, the uvw visual-field coordinate system is reset with respect to the virtual camera 1 subjected to control.

In Step S13, the field-of-view region determining unit 222 determines the field-of-view region 23 in the virtual space 2 based on the identified reference line of sight 5. After that, in Step S14, the field-of-view image generating unit 223 processes the virtual space data to generate (render) the field-of-view image 26 that is a part of the entire virtual space image 22 developed in the virtual space 2 to be projected onto (superimposed with) the field-of-view region 23 in the virtual space 2. In Step S15, the field-of-view image generating unit 223 outputs the generated field-of-view image 26 as a field-of-view image for update to the HMD 110. In Step S16, the HMD 110 displays the received field-of-view image 26 on the display 112 to update the field-of-view image 26. With this, when the user moves the HMD 110, the field-of-view image 26 is updated in synchronization therewith.

(Input Processing)

As described above, the input control unit 233 is configured to generate an input object and a determination object. The user can perform an input operation by operating the input object. More specifically, when the user performs an input operation, the user first selects an input object with a virtual body. Next, the user moves the selected input object to a determination region. The determination region is a region defined by the determination object. When the input object is moved to the determination region, the input determining unit 234 determines the input details.

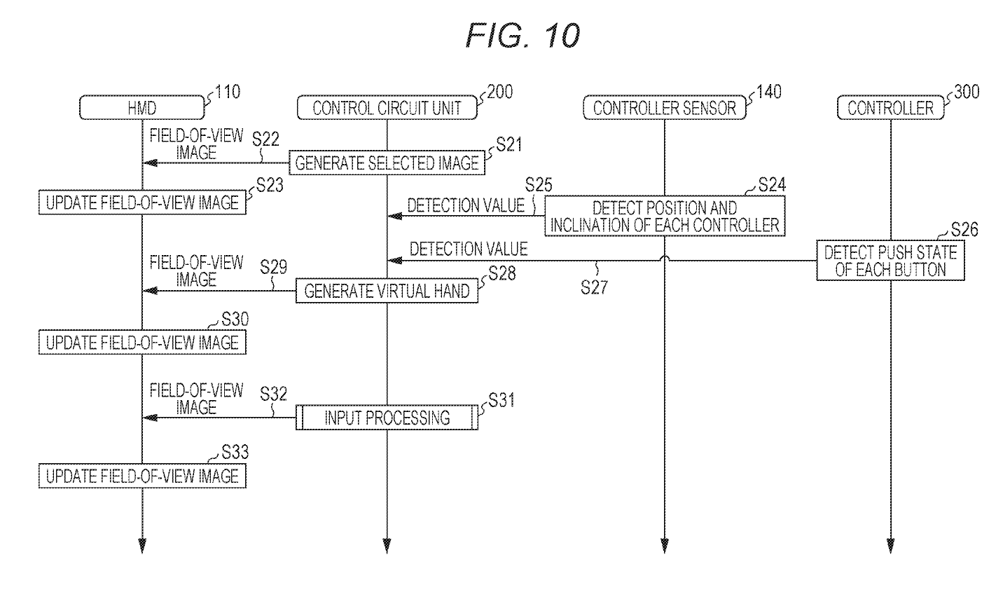

FIG. 10 is a sequence diagram of a flow of processing of the HMD system 100 receiving an input operation in the virtual space 2 according to at least one embodiment of this disclosure.

In Step S21 of FIG. 10, the input control unit 233 generates an input reception image including the input object and the determination object. In Step S22, the field-of-view image generation unit 223 outputs a field-of-view image containing the input object and the determination object to the HMD 110. In Step S23, the HMD 110 updates the field-of-view image by displaying the received field-of-view image on the display 112.

In Step S24, the controller sensor 140 detects the position and inclination of the right controller 320, and detects the position and inclination of the left controller 330. In Step S25, the controller sensor 140 transmits the detection values to the control circuit unit 200. The controller detecting unit 213 receives those detection values. In Step S26, the controller 300 detects the push state of each button. In Step S27, the right controller 320 and the left controller 330 transmit the detection values to the control circuit unit 200. The controller detecting unit 213 receives those detection values. In Step S28, the virtual hand control unit 232 uses the detection values received by the controller detecting unit 213 to generate virtual hands of the user in the virtual space 2. In Step S29, the virtual hand control unit 232 outputs a field-of-view image containing a virtual right hand HR and a virtual left hand HL as the virtual hands to the HMD 110. In Step S30, the HMD 110 updates the field-of-view image by displaying the received field-of-view image on the display 112.

In Step S31, the input control unit 233 and the input determining unit 234 execute input processing. The input processing is described later in detail.

In Step S32, the field-of-view image generation unit 223 outputs the field-of-view image being subjected to the input processing to the HMD 110. In Step S33, the HMD 110 updates the field-of-view image by displaying the received field-of-view image on the display 112.

(Flow of Example of Input Processing)

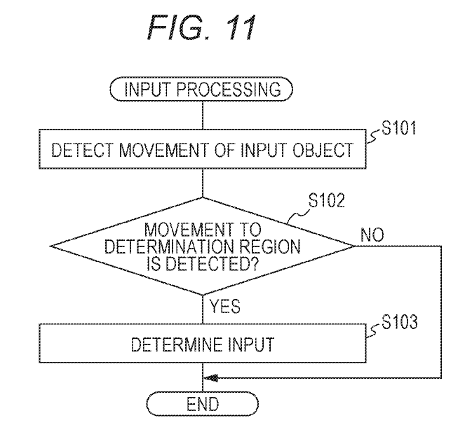

Now, a description is given of an exemplary flow of the input processing in Step S31 with reference to FIG. 11. FIG. 11 is a sequence diagram of an exemplary flow of the input processing according to at least one embodiment of this disclosure.

In Step S101, the input control unit 233 detects movement of the input object. In Step S102, the input control unit 233 determines whether or not the input object has moved to the determination region. When the input control unit 233 determines that the input object has moved to the determination region (YES in Step S102), the processing proceeds to Step S103. The input control unit 233 may determine whether or not the input object has moved to the determination region by determining whether or not the input object has established a predetermined positional relationship with the determination object. For example, the input control unit 233 may determine that the input object has established a predetermined positional relationship with the determination object when the input object has touched the determination object.

In Step S103, the input determining unit 234 determines, as details to be input, an input item that is associated with the input object when the input object has moved to the determination region. The virtual space control unit 230 receives the determined details to be input.

(Flow of Another Example of Input Processing)

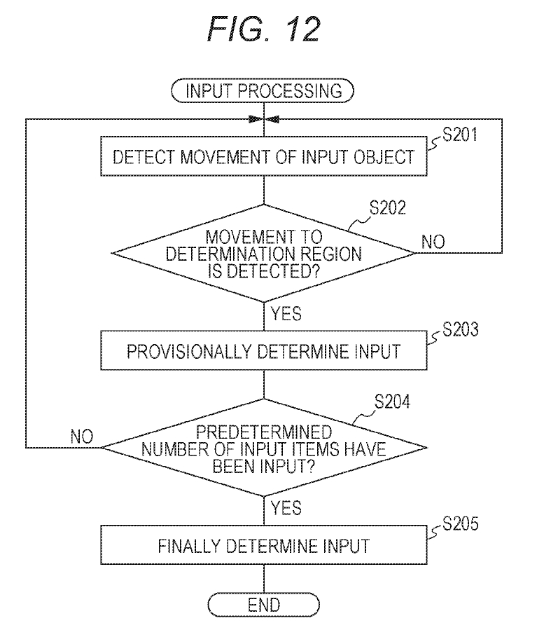

Now, a description is given of an exemplary flow of the input processing in Step S31 with reference to FIG. 12. FIG. 12 is a sequence diagram of an exemplary flow of the input processing according to at least one embodiment of this disclosure.

In Step S201, the input control unit 233 detects movement of the input object. In Step S202, the input control unit 233 determines whether or not the input object has moved to the determination region. When the input control unit 233 determines that the input object has moved to the determination region (YES in Step S202), the processing proceeds to Step S203. In Step S203, the input determining unit 234 provisionally determines, as details to be input, an input item that is associated with the input object when the input object has moved to the determination region.

In Step S204, the input determining unit 234 determines whether or not a predetermined number of input items are provisionally determined. When the predetermined number of input items are not provisionally determined (NO in Step S204), the processing returns to Step S201. On the other hand, when the predetermined number of input items are provisionally determined (YES in Step S204), in Step S205, the input determining unit 234 determines that input is complete, and determines the predetermined number of provisionally determined input items as details to be input. This is a final input determination. The virtual space control unit 230 receives the determined details to be input.

(Example of Input Processing)

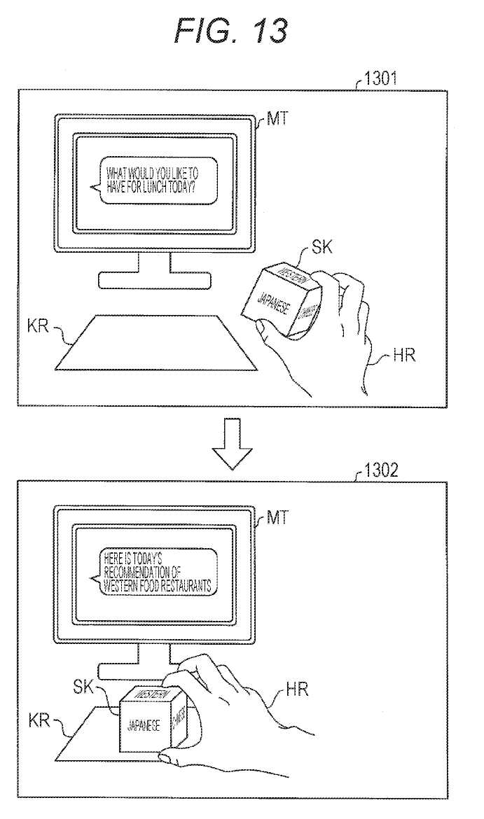

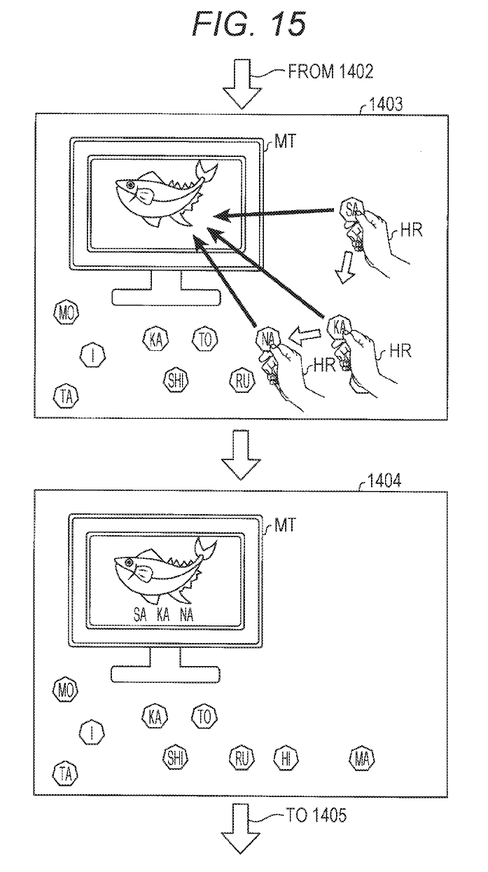

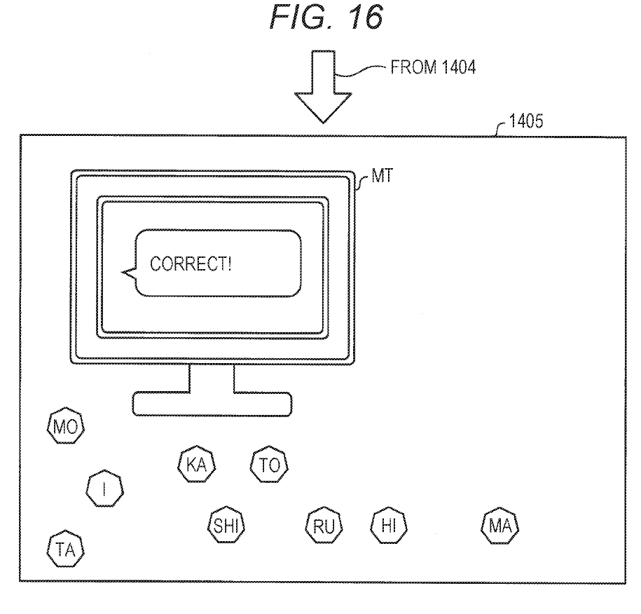

Next, a description is given of exemplary input processing in Step S31 described above with reference to FIG. 13 to FIG. 17.

(Exemplary Input Processing A)

Now, exemplary input processing A is described with reference to FIG. 13. FIG. 13 is a diagram of exemplary input processing A according to at least one embodiment of this disclosure. In exemplary input processing A, there is an example of processing of receiving, when a first surface of the input object has touched the determination object, input of an input item associated with a second surface having a predetermined positional relationship with the first surface.

In exemplary input processing A, a dice SK is set as the input object, and a board KR is set as the determination object. The user performs an input operation to cause the display to transition from a display example 1301 to a display example 1302.

The dice SK has a plurality of surfaces, and different input items are associated with the plurality of surfaces, respectively. Specifically, “Japanese”, “Western”, and “Chinese” are associated with the plurality of surfaces as the input items, respectively. The “Japanese” refers to Japanese food, “Western” refers to Western food, and “Chinese” refers to Chinese food.

In the display example 1301, “What would you like to have for lunch today?” is displayed on a field-of-view image monitor MT. The user performs an input operation by moving the dice SK with the virtual right hand HR and putting the dice SK on the board KR.

In the display example 1302, the bottom surface of the dice SK is in contact with the board KR, and a surface with the description of “Western” is the top surface. At this time, “Western” associated with the top surface of the dice SK is details to be input. That is, the user answers “Western food” to the question of “What would you like to have for lunch today?” In the display example 1302, “Here is today's recommendation of western food restaurants” is displayed on the monitor MT in response to the answer of “Western food”. This means that the next proposition is presented in response to the answer of the user.

The example described above has a configuration of receiving an input item associated with a surface having a predetermined positional relationship with the touched surface. However, the input item does not necessarily need to be received in this manner, and a configuration of receiving an input item associated with the touched surface may be adopted.

Further, as an example of the input object, the input object does not necessarily need to have a surface like that of the dice SK, but may have a shape of a ball stuck with pins associated with the input items. In this case, when a pin has touched the board KR, input of an input item associated with the pin may be received.

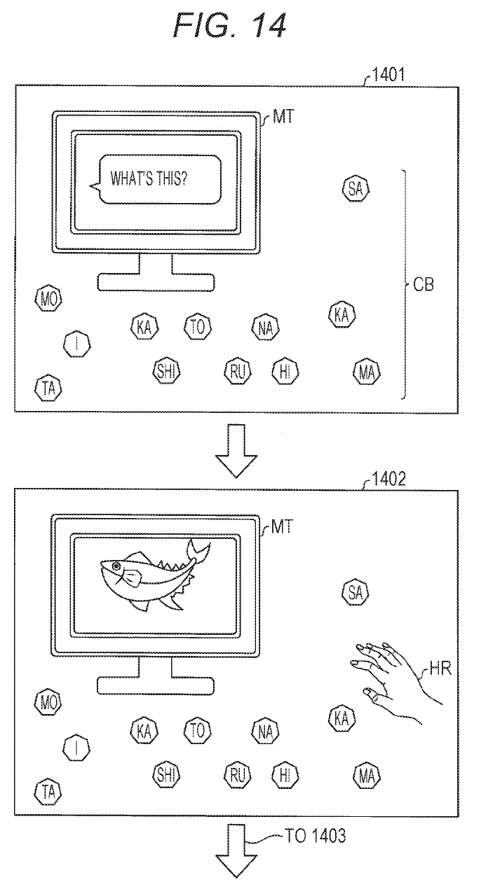

(Exemplary Input Processing B) Now, exemplary input processing B is described with reference to FIG. 14 to FIG. 16. FIG. 14 to FIG. 16 are diagrams of exemplary input processing B according to at least one embodiment of this disclosure. In exemplary input processing B, there is an example of processing of detecting, when a region defined in the virtual space and a position of at least one of a plurality of character objects have a predetermined positional relationship, movement of the at least one of the plurality of character objects to the determination region and receiving input of a character associated with the moved character object.

In the input processing B, a character object CB is set as the input object, and the monitor MT is set as the determination object. There are a plurality of character objects CB, and those character objects CB are associated with different characters, respectively.

In the input processing B, the user performs an input operation to cause the display to transition from a display example 1401 to a display example 1402, then, to a display example 1403, . . . , and to a display example 1405.

In the display example 1401, “What's this?” is displayed on the monitor MT. Further, the character objects CB are displayed. Next, in the display example 1402, a picture of a fish is displayed on the monitor MT. After that, the user moves the at least one sub-object of character object CB to the monitor MT with the virtual right hand HR, to thereby input each character.

In the display example 1403, the user uses the virtual right hand HR to move sub-objects of the character objects CB associated with “sa”, “ka”, and “na” (which are Japanese “hiragana” characters) to the monitor MT in the above-state order. With this, in a display example 1404, “sa”, “ka”, and “na” are input. In short, “What's this?” is displayed on the monitor MT, and after that, the user answers “sakana” (which means “fish” in Japanese) in response to display of the picture of a fish. In the display example 1405, “Correct!” is displayed on the monitor MT.

In the description given above, an example of performing an input operation by moving the character object CB to the monitor MT with the virtual right hand HR is described. However, the manner of performing an input operation is not limited to this example. The character object CB may be moved by being thrown away with the virtual right hand HR and hitting the monitor MT. Further, the determination object does not necessarily need to be the monitor MT, but may have a shape like a hole. The user may perform an input operation by dropping the character object CB into the hole.

(Exemplary Input Processing C)

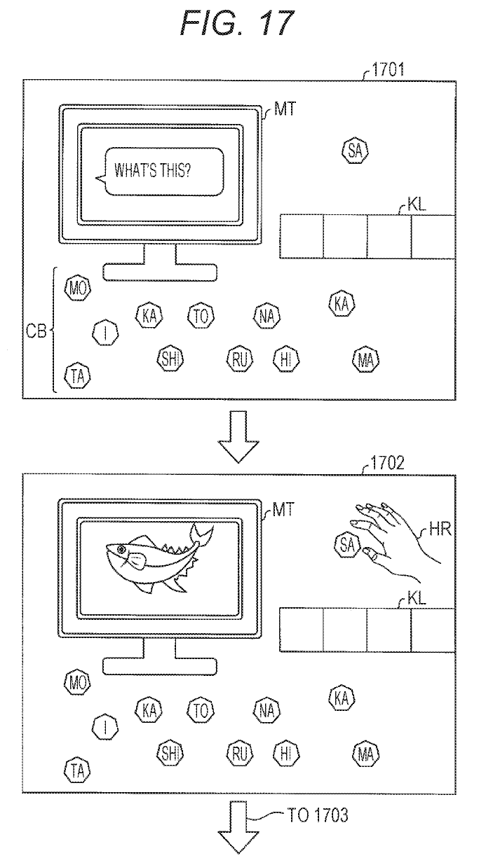

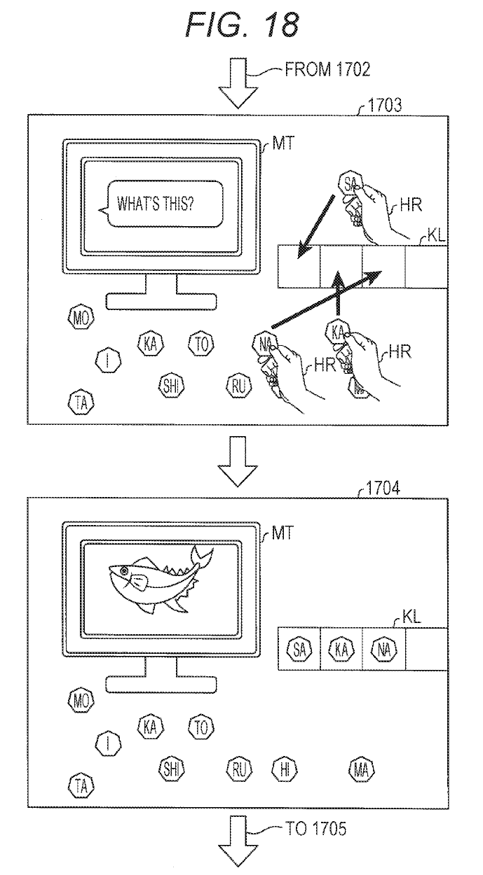

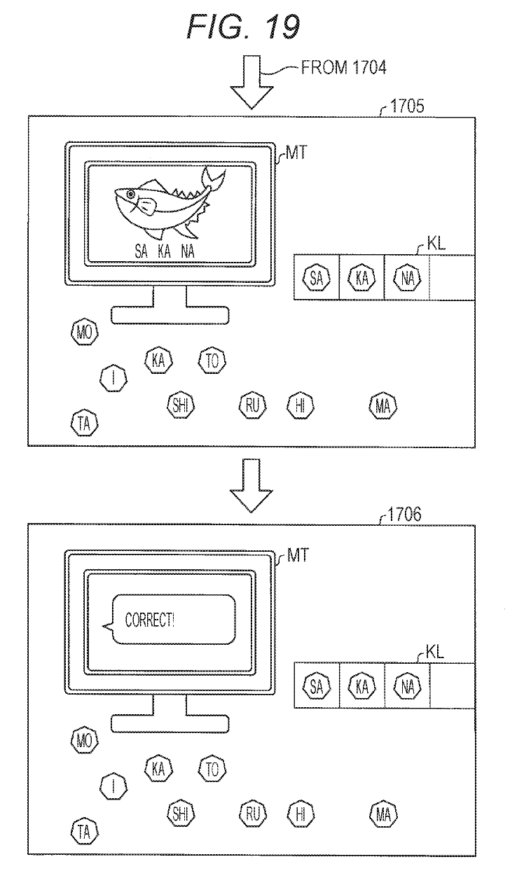

Now, exemplary input processing C is described with reference to FIG. 17 to FIG. 19. FIG. 17 to FIG. 19 are diagrams of exemplary input processing C according to at least one embodiment of this disclosure. In the input processing example C, there is an example of processing of receiving, when a predetermined number of character objects are set in a plurality of sections serving as input spaces placed in the virtual space, input of input items associated with the character objects set in the plurality of sections.

In the input processing C, a character object CB is set as the input object, and an input region KL is set as the determination object. There are a plurality of sub-objects of character object CB, and those character objects CB are associated with different characters, respectively. There are a plurality of sections in the input region KL in which the sub-objects of character object CB can be placed.

In the input processing C, the user performs an input operation to cause the display to transition from a display example 1701 to a display example 1702, then, to a display example 1703, . . . , and to a display example 1706.

In the display example 1701, “What's this?” is displayed on the monitor MT. Further, the character object CB is displayed. Further, the input region KL is also displayed. Next, in the display example 1702, a picture of a fish is displayed on the monitor MT. After that, the user moves the sub-objects of the character object CB to the input region KL with the virtual right hand HR, to thereby input each character. In the display example 1703, the user uses the virtual right hand HR to move the sub-objects of character object CB associated with “sa”, “ka”, and “na” to respective sections in the input region KL. The sub-objects of character object CB associated with “sa”, “ka”, and “no” are moved to the respective sections in the input region KL from the left of those sections. As a result, in a display example 1704, “sa”, “ka”, and “no” are input to the respective sections in the input region KL. In this manner, “sakana” (fish) is input as in a display example 1705. In short, “What's this?” is displayed on the monitor MT, and after that, the user answers “sakana” (fish) in response to display of the picture of a fish. In the display example 1706, “Correct!” is displayed on the monitor MT.

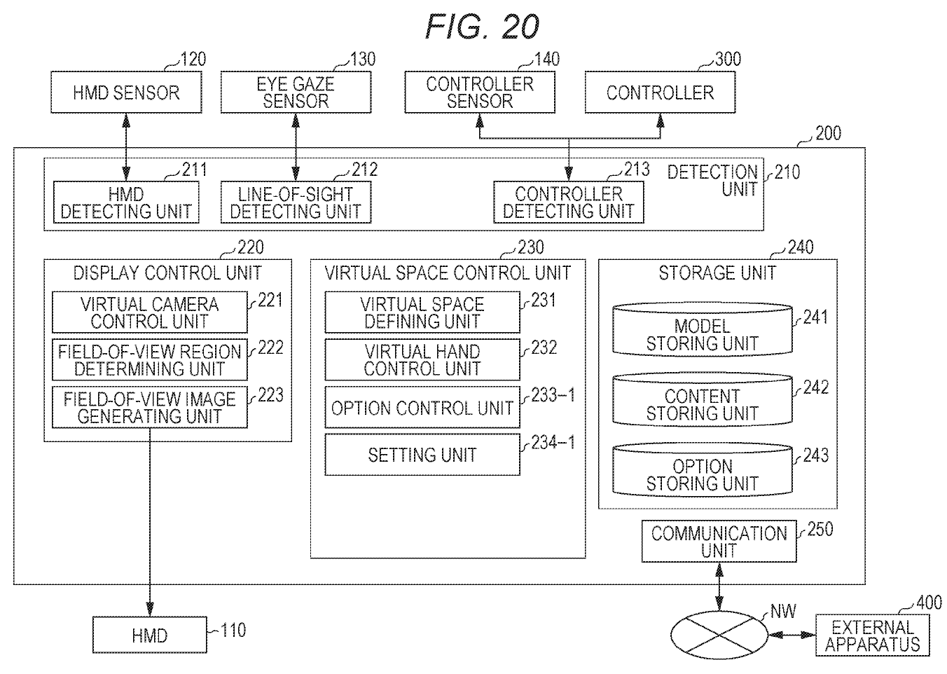

FIG. 20 is a block diagram of a functional configuration of the control circuit unit 200 according to at least one embodiment of this disclosure. The control circuit unit 200 in FIG. 20 has a configuration similar to that of the control circuit unit 200 in FIG. 8. However, the control circuit unit 200 in FIG. 20 is different from the control circuit unit 200 in FIG. 8 in configuration of the virtual space control unit 230.

The virtual space control unit 230 is configured to control the virtual space 2 to be provided to the user. The virtual space control unit 230 includes a virtual space defining unit 231, a virtual hand control unit 232, an option control unit 233-1, and a setting unit 234-1.

The virtual space defining unit 231 is configured to generate virtual space data representing the virtual space 2 to be provided to the user, to thereby define the virtual space 2 in the HMD system 100. The virtual hand control unit 232 is configured to arrange each virtual hand (virtual right hand and virtual left hand) of the user in the virtual space 2 depending on operations of the right controller 320 and the left controller 330 by the user. The virtual space defining unit 231 is also configured to control behavior of each virtual hand in the virtual space 2.

The option control unit 233-1 places a user interface (UI) object, which is a virtual object for receiving selection of an option, in the virtual space 2. Then, the option control unit 233-1 receives selection of an option based on behavior of a virtual body exerted on the UI object. The virtual body is a virtual object that moves in synchronization with movement of a part of the body of the user other than the head. In at least one embodiment, a description is given of an example in which the virtual body is a virtual hand.

The option control unit 233-1 generates a UI object containing a display region. The option control unit 233-1 displays options that can be selected by the user on the display region. Further, the UI object generated by the option control unit 233-1 contains an operation part. The option control unit 233-1 switches between options to be displayed on the display region depending on a user's operation performed on the operation part via the virtual body.

The setting unit 234-1 sets an operation mode of the HMD system 100.

(Processing of Causing User to Select Option and Example of Display Thereof)

As described above, the option control unit 233-1 generates a UI object. Then, the user can operate this UI object to select a desired option among a plurality of options. More specifically, when the user selects an option, the user first selects an operation part of the UI object with the virtual body. Then, the user moves the virtual body with the operation part being selected with the virtual body, to thereby move the position of the operation part in the UI object. The user can switch between a plurality of options by those operations. In this manner, in selection of an option through use of the UI object, the user switches between options by performing an operation of selecting and moving the operation part with the virtual body. With this, according to the HMD system 100, it is possible to improve the virtual experience of the user by enabling the user to recognize the fact that an operation is performed reliably.

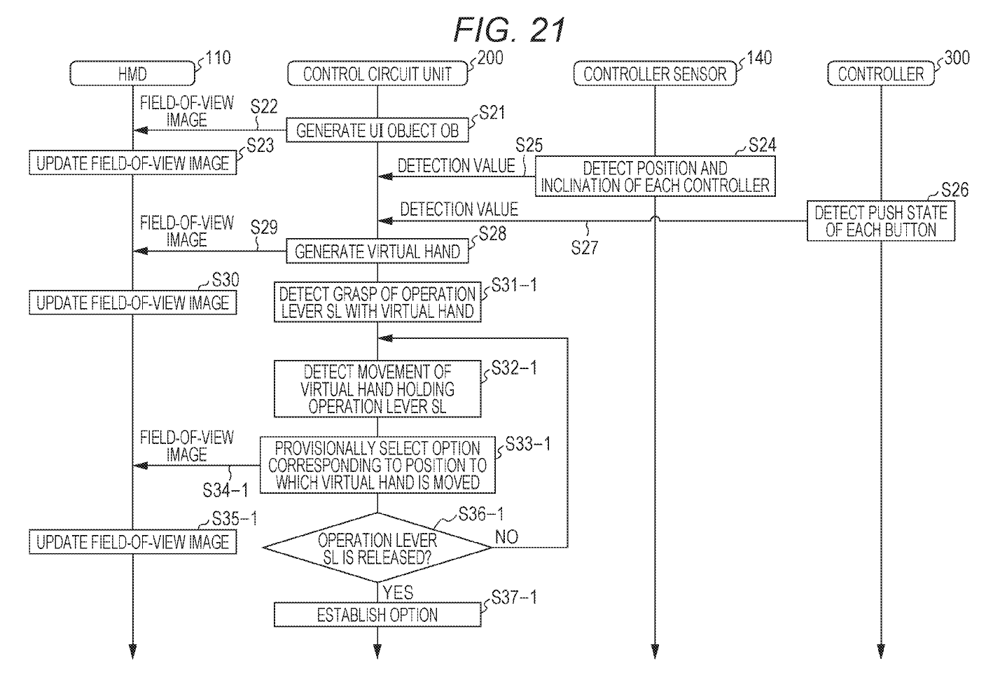

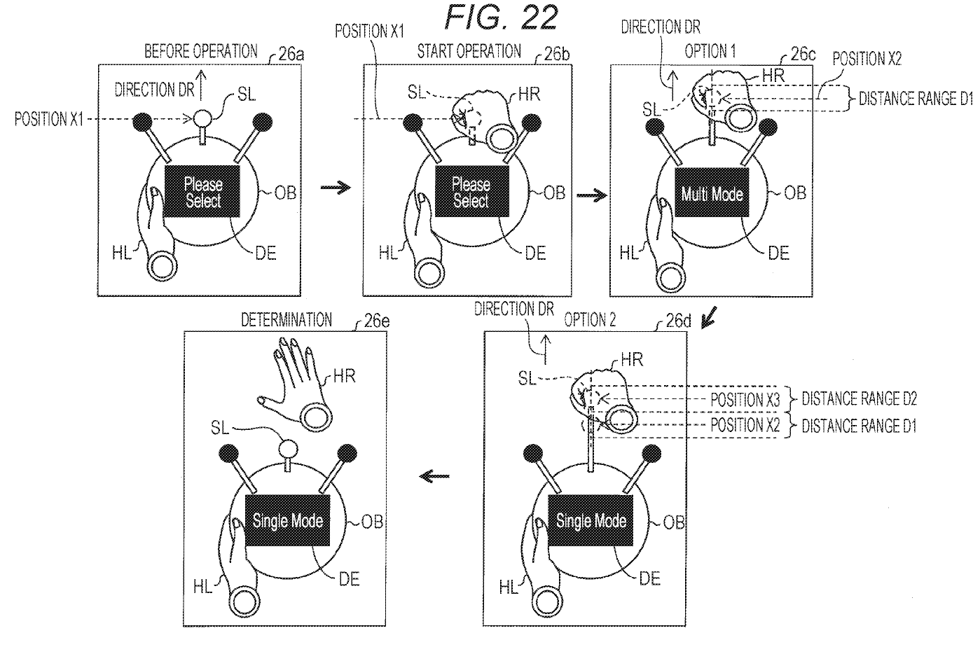

In the following, a description is given of processing of the HMD system 100 causing the user to select an option and an example of the field-of-view image 26 to be displayed on the display 112 through the processing with reference to FIG. 21 and FIG. 22. In the following, the description is given of an example in which the UI object is a UI object OB containing an operation lever SL as the operation part and the virtual body for selecting the operation part is the virtual hand. Further, in at least one embodiment, the user's operation for selecting the operation part with the virtual body is an operation to move the virtual hand to a position at which the virtual hand is in contact with or close to the operation lever SL, and cause the virtual hand to perform a grasp operation at the position. That is, when the operation lever SL is grasped with the virtual hand, the option control unit 233-1 detects that the operation lever SL is selected with the virtual hand. Further, the description is given of an example in which the options that can be selected by the user via the UI object OB include an option “Single Mode”, which is a mode of operation of the HMD system 100, and an option “Multi Mode”, which is another mode of operation. When selection of the option “Multi Mode” is established, the setting unit 234-1 causes the HMD system. 100 to operate in the “Multi Mode”. On the other hand, when selection of the option “Single Mode” is established, the setting unit 234-1 causes the HMD system 100 to operate in the “Single Mode”.

FIG. 21 is a sequence diagram of a flow of processing of the HMD system 100 causing the user to select an option with the UI object in the virtual space 2 according to at least one embodiment of this disclosure. Further, FIG. 22 is a diagram of an example of the field-of-view image 26 to be displayed on the display 112 through the processing of FIG. 21 according to at least one embodiment of this disclosure. The field-of-view image 26 to be displayed on the display 112 switches from a field-of-view image 26a to a field-of-view image 26e sequentially through a series of operations by the user.

In Step S21, the option control unit 233-1 generates the UI object OB. In FIG. 22, the UI object OB contains the operation lever SL and a display region DE. When the option control unit 233-1 detects a user's operation to move the virtual hand in a direction DR under a state in which the operation lever SL is selected with the virtual hand, the option control unit 233-1 moves the operation lever SL along the direction DR. In the field-of-view image 26a, the UI object OB in its initial state has the operation lever SL displayed at a position X1 (first position), which is an initial position. Further, “Please Select” (first information), which is a character string for urging the user to perform a selection operation, is displayed on the display region DE as an initial image.

Step S22 to Step S30 are similar to Step S22 to Step S30 in FIG. 10.

In Step S31-1, the option control unit 233-1 detects grasp of the operation lever SL with the virtual hand. For example, the option control unit 233-1 may detect grasp of the operation lever SL with the virtual right hand HR when the virtual hand control unit 232 causes the virtual right hand HR to be moved to a position at which the virtual right hand HR is in contact with or close to the operation lever SL, and the operation lever SL is grasped with the virtual right hand HR at that position. The user's operation for causing the virtual right hand HR to perform a grasp operation is, for example, an operation to push each button of the right controller 320.

The field-of-view image 26b represents a state of the virtual right hand HR holding the operation lever SL at the position X1, which is an initial position, namely, a state of the user selecting the operation lever SL with the virtual right hand HR.

In Step S32-1, the option control unit 233-1 detects that the virtual hand is moved with the operation lever SL being grasped. That is, the option control unit 233-1 detects that the operation lever SL is moved in a certain direction with the virtual hand with the operation lever SL being selected with the virtual hand. For example, the option control unit 233-1 detects that the virtual hand is holding the operation lever SL and the virtual hand has moved in the direction DR based on the detection values of the position and inclination of the controllers.

In Step S33-1, the option control unit 233-1 sets, to a provisionally selected state, a predetermined option corresponding to a position to which the virtual hand is moved among a plurality of options set in advance. The provisionally selected state means that one option is selected from among the plurality of options but the selection is not established. Through processing of Step S37-1 described later, the option control unit 233-1 establishes selection of the option in the provisionally selected state. That is, the option control unit 233-1 enables selection of an option corresponding to the position to which the virtual hand is moved. The option control unit 233-1 may display, on the display region DE, information (second information) associated with the option in the provisionally selected state. With this, the user can clearly recognize the option in the provisionally selected state.

In Step S34-1, the field-of-view image generation unit 223 outputs the field-of-view image containing the UI object OB to the HMD 110. In Step S35-1, the HMD 110 updates the field-of-view image by displaying the received field-of-view image on the display 112. The updated field-of-view image may be an image like the field-of-view image 26c, for example. In this example, the virtual hand control unit 232 moves the virtual right hand HR holding the operation lever SL in the direction DR. Then, the option control unit 233-1 moves the operation lever SL from the position X1, which is the initial position, to a position X2 (second position). Further, the option control unit 233-1 displays, on the display region DE, a character string “Multi Mode” indicating the option in the provisionally selected state. In this example, the user can set the option “Multi Mode” to the provisionally selected state as if the user were grasping and pulling the operation lever SL in the real space.

The position X2 may have a margin for setting the option “Multi Mode” to the provisionally selected state. For example, the option “Multi Mode” may be set to the provisionally selected state when the operation lever SL is positioned within a predetermined distance range D1 (first distance range) containing the position X2. Further, the option control unit 233-1 may further execute a step of vibrating the part of the body of the user via the controller 300 by vibrating the controller 300 via the control circuit unit 200 when the option is set to the provisionally selected state. With this, the user can reliably recognize the fact that the option is set to the provisionally selected state.

In Step S36-1, the option control unit 233-1 determines whether or not the virtual hand has released the operation lever SL. The option control unit 233-1 can determine whether or not the virtual hand has released the operation lever SL based on each detection value received from the controller 300 by the control circuit unit 200. When the option control unit 233-1 determines that the virtual hand has not released the operation lever SL (NO in Step S36-1), the processing returns to Step S32-1, and the option control unit 233-1 detects that the virtual hand is moved with the operation lever SL being grasped. Then, in Step S33-1, the option control unit 233-1 switches the option in the provisionally selected state to an option corresponding to the position to which the virtual hand is moved. After that, through the processing of Step S34-1, the control circuit unit 200 transmits the field-of-view image to the HMD 110, and the HMD 110 updates the field-of-view image through the processing of Step S35-1.

The updated field-of-view image may be an image like the field-of-view image 26d, for example. In this example, the virtual hand control unit 232 further moves the virtual right hand HR holding the operation lever SL to the direction DR. Then, the option control unit 233-1 moves the operation lever SL from the position X2 to a position X3 (third position). Further, when the operation lever SL is positioned at the position X3, the option control unit 233-1 displays a character string “Single Mode” indicating the option in the provisionally selected state on the display region DE. That is, the option in the provisionally selected state is “Multi Mode” on the field-of-view image 26c, but the option in the provisionally selected state is switched to “Single Mode” on the field-of-view image 26d.

The position X3 may also have a margin for setting the option “Single Mode” to the provisionally selected state. For example, the option “Single Mode” may be set to the provisionally selected state when the operation lever SL is positioned within a predetermined distance range D2 (second distance range) containing the position X3. Further, the option control unit 233-1 may further execute a step of applying vibration to the user by vibrating the controller 300 via the control circuit unit 200 when the option in the provisionally selected state is changed. With this, the user can reliably recognize the fact that the option in the provisionally selected state is changed.

In Step S36-1, when the option control unit 233-1 determines that the virtual hand has released the operation lever SL (YES in Step S36-1), the option control unit 233-1 maintains the provisionally selected state of the option. That is, the option control unit 233-1 does not change the option in the provisionally selected state after the virtual hand has released the operation lever SL. Then, the option control unit 233-1 establishes selection of the option in the provisionally selected state (Step S37-1). For example, when the option control unit 233-1 establishes selection of the option “Multi Mode”, the setting unit 234-1 operates the HMD system. 100 in the “Multi Mode”. On the other hand, when the option control unit 233-1 establishes selection of the option “Single Mode”, the setting unit 234-1 operates the HMD system 100 in the “Single Mode”.

Further, when the option control unit 233-1 determines that the virtual hand has released the operation lever SL, the option control unit 233-1 returns the operation lever SL to the initial position. Thus, when the operation lever SL is returned to the initial position, the option control unit 233-1 maintains the selectable state of the option that has been set to the provisionally selected state when the virtual hand has released the operation lever SL. In this case, the option control unit 233-1 establishes selection of the option. The field-of-view image generation unit 223 transmits, to the HMD 110, the field-of-view image of the UI object OB whose operation lever SL has returned to the initial position, and the HMD 110 updates the field-of-view image.

The updated field-of-view image may be an image like the field-of-view image 26e, for example. In this example, the virtual hand control unit 232 displays the virtual right hand HR with fingers being extended. The option control unit 233-1 displays the operation lever SL at the initial position. Further, the option control unit 233-1 displays the character string “Single Mode” indicating the established option on the display region DE. That is, in this example, there is an example of the field-of-view image to be displayed when the virtual hand has released the operation lever SL under a state of the field-of-view image 26d in which the option “Single Mode” is in the provisionally selected state. When the virtual hand has released the operation lever SL under a state of the field-of-view image 26c in which the option “Multi Mode” is in the provisionally selected state, the option control unit 233-1 displays, on the display region DE, the character string “Multi Mode” indicating the established option.

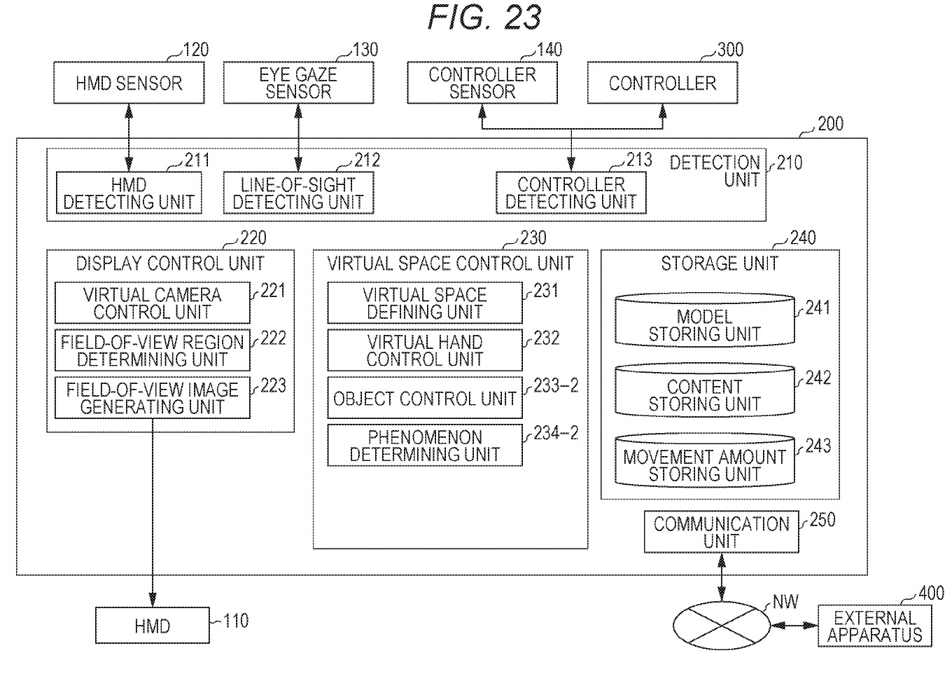

FIG. 23 a block diagram of a functional configuration of the control circuit unit 200 according to at least one embodiment of this disclosure. The control circuit unit 200 in FIG. 23 has a configuration similar to that of the control circuit unit 200 in FIG. 8. However, the control circuit unit 200 in FIG. 23 is different from the control circuit unit 200 in FIG. 8 in configuration of the virtual space control unit 230.

The virtual space control unit 230 is configured to control the virtual space 2 to be provided to the user. The virtual space control unit 230 includes a virtual space defining unit 231, a virtual hand control unit 232, an object control unit 233-2, and an event determining unit 234-2.

The virtual space defining unit 231 is configured to generate virtual space data representing the virtual space 2 to be provided to the user, to thereby define the virtual space 2 in the HMD system 100. The virtual hand control unit 232 is configured to arrange each virtual hand (virtual right hand and virtual left hand) of the user in the virtual space 2 depending on operations of the right controller 320 and the left controller 330 by the user, and to control behavior of each virtual hand in the virtual space 2.

The object control unit 233-2 is configured to arrange a virtual object in the virtual space 2, and to control behavior of the virtual object in the virtual space 2. The virtual object to be controlled by the object control unit 233-2 includes a user interface (hereinafter referred to as “UI”) object. The UI object is a virtual object that functions as a UI for presenting to the user a direction in which an event has occurred. The object control unit 233-2 controls the UI object based on a movement amount stored in a movement amount storing unit 243 described later.

The event determining unit 234-2 determines whether or not an event has occurred in a blind spot of the virtual camera 1 based on behavior of the virtual object arranged in the virtual space 2. The event determining unit 234-2 identifies a direction of occurrence of an event when the event has occurred in the blind spot. The blind spot of the virtual camera 1 refers to a space in the virtual space 2 that does not contain an azimuth angle β (refer to FIG. 5B) around the reference line of sight 5. On the other hand, the space containing the azimuth angle β is referred to as the field of view of the virtual camera 1.

<Outline of Control Method>

The object control unit 233-2 arranges a UI object capable of being moved to the field of view of the virtual camera 1 in the blind spot of the virtual camera 1 based on the identified position of the virtual camera 1. The event determining unit 234-2 determines whether or not an event has occurred in the blind spot. When an event has occurred in the blind spot, the event determining unit 234-2 identifies the direction in which the event has occurred. When an event has occurred in the blind spot, the object control unit 233-2 moves the UI object toward the field of view by a movement amount corresponding to the direction identified by the event determining unit 234-2.

<Details of Control Method>

(Example of Details of Control Method)

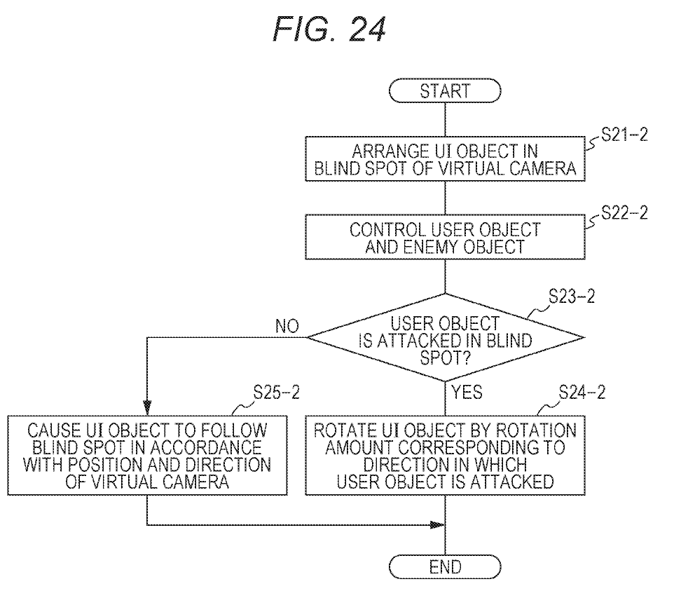

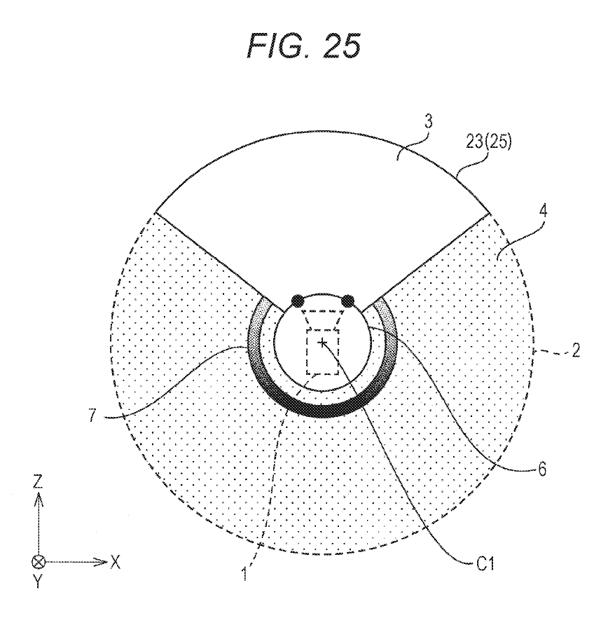

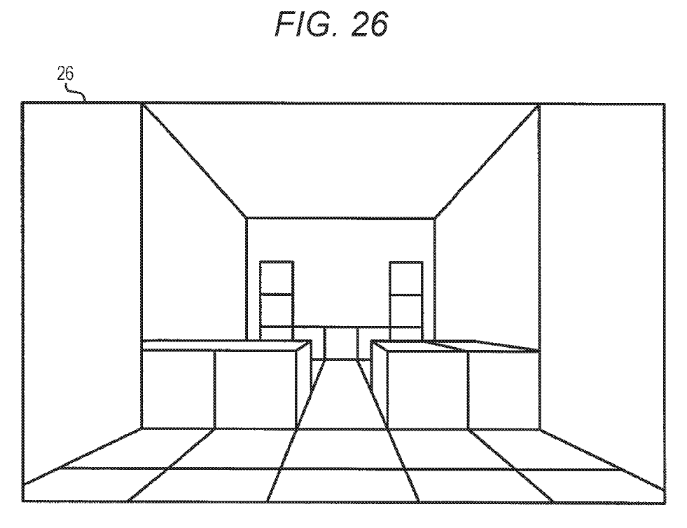

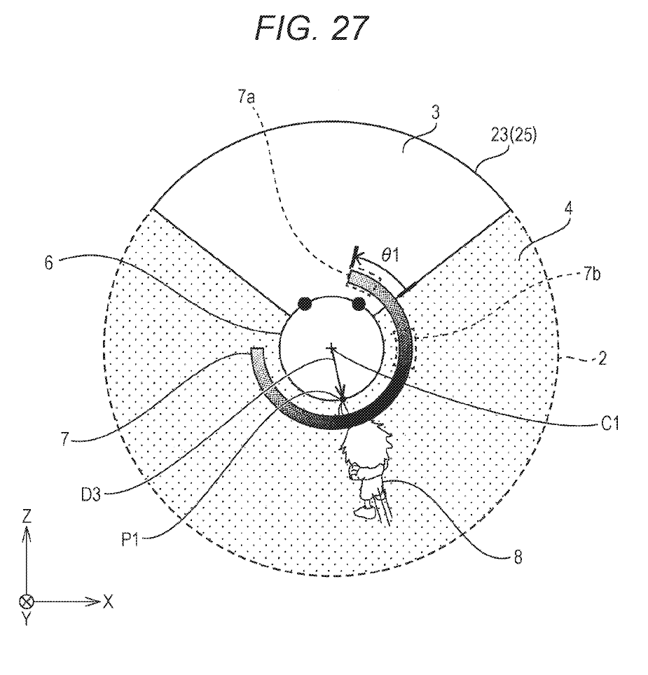

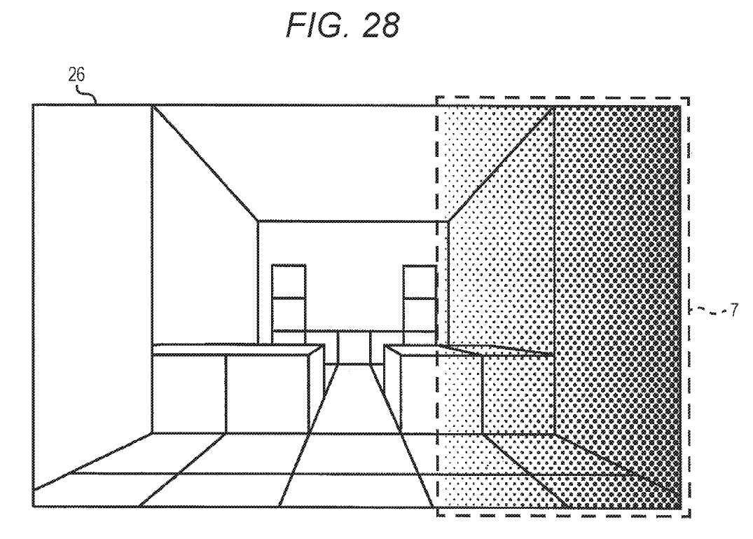

FIG. 24 is a flowchart of a flow of processing in an exemplary control method to be performed by the HMD system 100 according to at least one embodiment of this disclosure. FIG. 25 is a diagram of an example of arrangement of virtual objects exhibited when a user object 6 is not attacked in a blind spot 4 according to at least one embodiment of this disclosure. FIG. 26 is a diagram of an example of the field-of-view image 26 generated based on the arrangement in FIG. 25 according to at least one embodiment of this disclosure. FIG. 27 is a diagram of an example of arrangement of virtual objects exhibited when the user object 6 is attacked from a certain direction in the blind spot 4 according to at least one embodiment of this disclosure. FIG. 28 is a diagram of an example of the field-of-view image 26 generated based on the arrangement in FIG. 27 according to at least one embodiment of this disclosure.

In this example, the UI object is a UI object 7 having a shape of surrounding the virtual camera 1. The UI object 7 may be a ball covering the head of the user object 6, which has an opening so as not to interrupt the field of view 3. Movement of the UI object 7 means rotation of the UI object 7. For example, the object control unit 233-2 rotates the UI object 7 toward the field of view 3 along the u axis or the v axis in the uvw coordinate system.

The object control unit 233-2 controls the user object 6 and an enemy object 8 in addition to the UI object 7. The user object is a virtual object that acts in the virtual space 2 in synchronization with the user's operation. The user object 6 is arranged in, for example, the virtual camera 1 in an overlapping manner. The enemy object 8 is a virtual object that attacks the user object 6 in the virtual space 2. For example, the enemy object 8 is an enemy character itself that attacks the user object 6. The enemy object 8 may be an object, for example, a weapon, to be used by the enemy character itself to attack the user object 6.

Occurrence of an event in the blind spot 4 means that the user object 6 is attacked by the enemy object 8 in the blind spot 4. The direction of occurrence of the event is a direction in which the user object 6 is attacked in the blind spot 4. The movement amount storing unit 243 stores a rotation amount for rotating the UI object 7 as a movement amount of the UI object 7 in association with the direction in which the user object 6 is attacked. The movement amount storing unit 243 stores a larger rotation amount as the direction associated with the rotation amount becomes closer to a position straight behind the user object 6.

In Step S12 of FIG. 9, when the virtual camera 1 is identified, in Step S21-2, the object control unit 233-2 arranges the UI object 7 in the blind spot 4 of the virtual camera 1 (refer to FIG. 25). In this case, not even a part of the UI object 7 is projected onto the field-of-view region 23. Thus, the field-of-view image 26 that does not contain the UI object 7 is displayed on the HMD 110 (refer to FIG. 26).

In Step S22-2, the object control unit 233-2 controls behavior of the user object 6 and the enemy object 8.

In Step S23-2, the event determining unit 234-2 determines whether or not the user object 6 is attacked by the enemy object 8 in the blind spot 4. For example, the event determining unit 234-2 determines that the user object 6 is attacked based on the fact that the enemy object 8 has touched the user object 6 in the virtual space 2. When the event determining unit 234-2 determines that the user object 6 is attacked, the event determining unit 234-2 determines the direction from which the user object 6 is attacked. For example, the event determining unit 234-2 identifies, as the direction from which the user object 6 is attacked, the direction extending from the position of the virtual camera 1 toward the position at which the user object 6 and the enemy object 8 have touched each other. In the example of FIG. 27, the event determining unit 234-2 identifies, as a direction D3 in which the user object 6 is attacked, the direction of extending from a position C1 of the virtual camera 1 toward the a touch position P1.

In the case of the determination of “YES” in Step S23-2, in Step S24-2, the object control unit 233-2 refers to the movement amount storing unit 243 to identify a rotation amount 81 corresponding to the direction D3 in which the user object 6 is attacked. The object control unit 233-2 rotates the UI object 7 toward the field of view 3 of the virtual cameral by the identified rotation amount 81.

The object control unit 233-2 may rotate the UI object 7 in the rotation direction corresponding to the direction in which the user object 6 is attacked. The movement amount storing unit 243 stores the rotation direction in association with whether the direction in which the user object 6 is attacked points to the right side or left side of the user object 6. For example, the counterclockwise rotation direction is stored in association with the right side, and the clockwise rotation direction is stored in association with the left side. The object control unit 233-2 identifies the rotation direction of the UI object 7 with reference to the movement amount storing unit 243.

The direction D3 points to the right side of the user object 6. The object control unit 233-2 identifies the counterclockwise direction as the rotation direction corresponding to the direction D3. The object control unit 233-2 rotates the UI object 7 by the rotation amount θ1 in the counterclockwise direction. The part corresponding to the rotation amount θ1 in the UI object 7 is projected onto the field-of-view region 23 so as to cover a part of the right side of the field of view 3. The field-of-view image 26 containing the part in the UI object 7 on the right side is displayed on the HMD 110 (refer to FIG. 28). The user recognizes the UI object 7 contained in the field-of-view image 26 to intuitively recognize from which direction in the blind spot 4 the user object 6 is attacked.

In the case of the determination of “NO” in Step S23-2, in Step S25-2, the object control unit 233-2 may cause the UI object 7 to follow the blind spot 4 of the virtual camera 1 in accordance with the position and direction of the virtual camera 1.

(Detailed Example of Control Method)

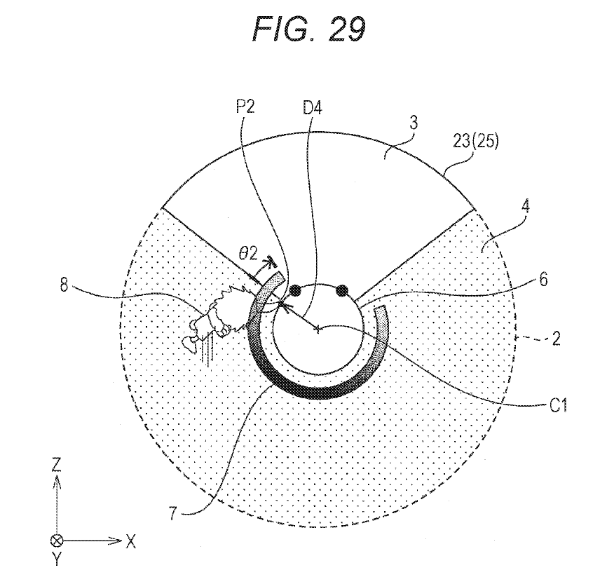

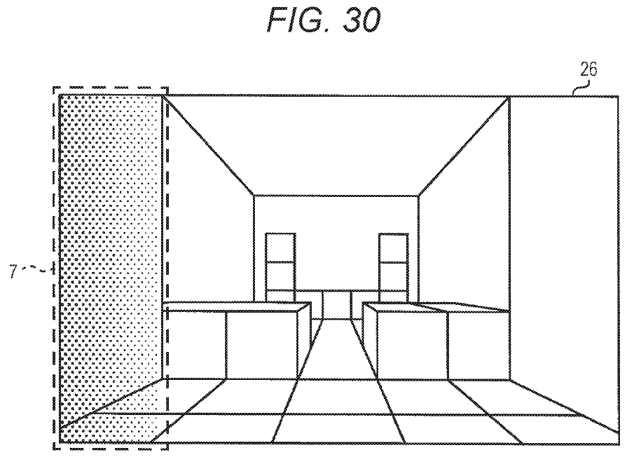

FIG. 29 is a diagram of an example of arrangement of virtual objects exhibited when the user object 6 is attacked in the blind spot 4 from another direction according to at least one embodiment. FIG. 30 is a diagram of an example of the field-of-view image 26 generated based on the arrangement illustrated in FIG. 29 according to at least one embodiment.

The event determining unit 234-2 determines that the user object 6 is attacked by the enemy object 8. The event determining unit 234-2 determines the direction extending from the position C1 of the virtual camera 1 toward a touch position P2 as a direction D4 in which the user object 6 is attacked. The touch position P2 is farther from the position straight behind the user object 6 than the touch position P1. The direction D4 is farther from the position straight behind the user object 6 than the direction D3. In comparison with the direction D3, the direction D4 points to the left side of the user object 6. The object control unit 233-2 identifies a rotation amount 82, which is smaller than the rotation amount 81, as the rotation amount corresponding to the direction D4. The object control unit 233-2 identifies the clockwise direction as the rotation direction corresponding to the direction D4. The object control unit 233-2 rotates the UI object 7 by the rotation amount θ2 in the clockwise direction. The part corresponding to the rotation amount θ2 in the UI object 7 is projected onto the field-of-view region 23 so as to cover a part of the left side of the field of view 3. The field-of-view image 26 containing the part in the UI object 7 on the left side is displayed on the HMD 110 (refer to FIG. 30).

(Detailed Example of Control Method)

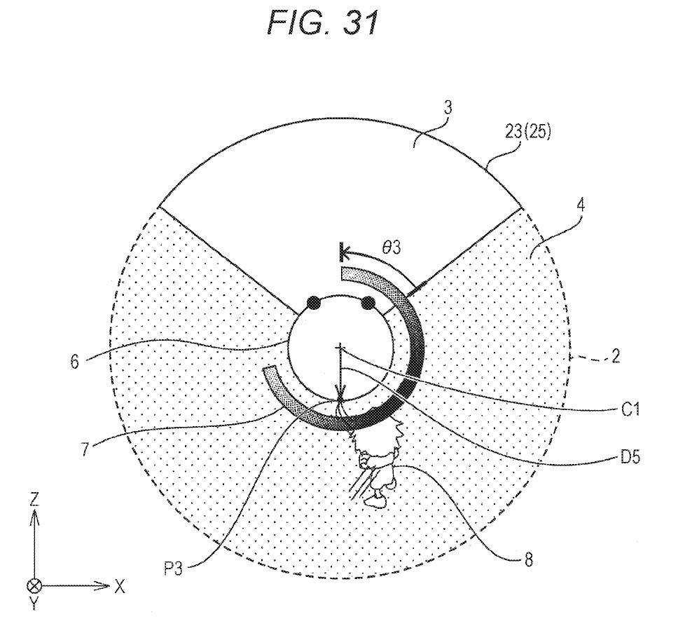

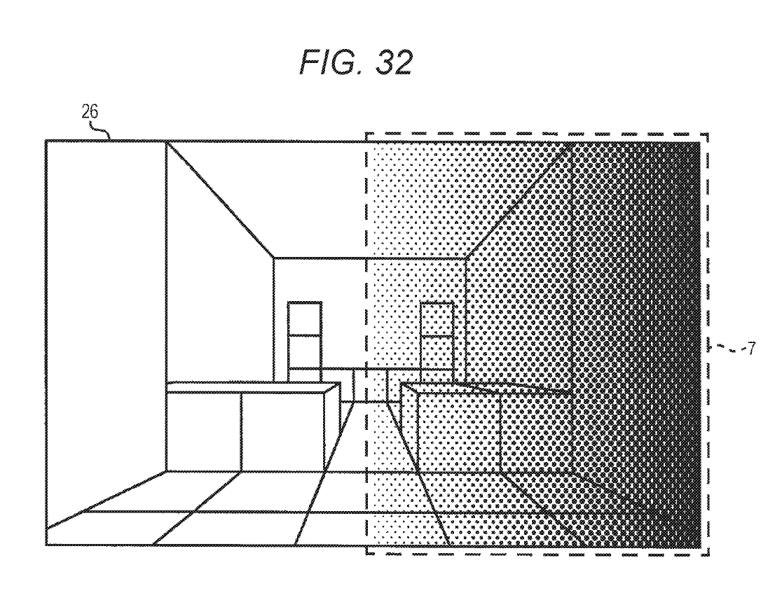

FIG. 31 is a diagram of an example of arrangement of virtual objects exhibited when the user object 6 is attacked in the blind spot 4 from yet another direction according to at least one embodiment of this disclosure. FIG. 32 is a diagram of an example of the field-of-view image 26 generated based on the arrangement in FIG. 31 according to at least one embodiment of this disclosure.

The event determining unit 234-2 determines that the user object 6 is attacked by the enemy object 8. The event determining unit 234-2 determines the direction extending from the position C1 of the virtual camera 1 toward a touch position P3 as a direction D5 in which the user object 6 is attacked. The touch position P3 is straight behind the user object 6. The direction D5 points straight behind the user object 6. The object control unit 233-2 refers to the movement amount storing unit 243 to identify a rotation amount θ3, which is larger than the rotation amount θ1 and the rotation amount θ2, as the rotation amount corresponding to the direction D5.

The direction D5 does not point to any one of the right side and left side of the user object 6. The object control unit 233-2 identifies on which of the right side and left side of the user object 6 the enemy object 8 that has attacked the user object 6 is located. For example, when the enemy object 8 is arranged across the right and left side of the user object 6, the object control unit 233-2 identifies that the enemy object 8 is located on the side occupied by a larger part of the enemy object 8. When the object control unit 233-2 identifies that the enemy object 8 is located on the right side, the object control unit 233-2 identifies the rotation direction in a manner similar to the case of the user object 6 being attacked from the right side. When the object control unit 233-2 identifies that the enemy object 8 is located on the left side, the object control unit 233-2 identifies the rotation direction in a manner similar to the case of the user object 6 being attacked from the left side.

In the example of FIG. 31, a larger part of the enemy object 8 is arranged on the right side of the user object 6. The object control unit 233-2 thus identifies that the enemy object 8 is located on the right side. The object control unit 233-2 refers to the movement amount storing unit 243 to identify the counterclockwise direction corresponding to the right side as the rotation direction. The object control unit 233-2 rotates the UI object 7 by the rotation amount θ3 in the counterclockwise direction. The part corresponding to the rotation amount θ3 in the UI object 7 is projected onto the field-of-view region 23 so as to cover a part of the right side of the field of view 3. The field-of-view image 26 containing the part in the UI object 7 in its right half is displayed on the HMD 110 (refer to FIG. 32).

When the direction D5 is identified, the object control unit 233-2 may rotate the UI object 7 once. As a result, all of the openings of the UI object 7 are temporarily contained in the blind spot 4, and all the directions of the field of view 3 of the virtual camera 1 are interrupted by the UI object 7. For example, when a part of the UI object 7 surrounding the back of the user object 6 when an event does not occur is black, the part is contained in the field of view 3 when the UI object 7 rotates 180 degrees. At this time, the dark field-of-view image 26 is generated. Therefore, the display 112 of the HMD 110 is blacked out instantaneously. With this, the user can intuitively recognize the fact that the user is attacked from straight behind himself or herself.

The UI object 7 may have gradated colors so that a first color (e.g., faint gray color) of a first part (e.g., part 7a indicated by FIG. 27) of the UI object 7, which requires a smaller rotation amount to enter the field of view 3, transitions to a second color (e.g., dark brown color) of a second part (e.g., part 7b) of the UI object 7, which requires a larger rotation amount to enter the field of view 3. In the UI object 7, the transmittance of color applied to the first part, which requires a smaller rotation amount to enter the field of view 3, may gradually change to the transmittance of color applied to the second part, which requires a larger rotation amount to enter the field of view 3. For example, the transmittance of color may gradually decrease from the first part to the second part. As an location of the direction of attack in the blind spot 4 with respect to the field-of-view direction becomes closer to straight behind user object 6, the field-of-view image 26 containing a part whose color is closer to the second color or a part that has a lower color transmittance of the UI object 7 is displayed. With this, the user can recognize the direction of attack in the blind spot 4 more intuitively. In addition, the user can recognize how far into the blind spot 4 the attack came from.

In at least one embodiment, the object control unit 233-2 may increase or decrease the size of the UI object 7 depending on the amount of damage given to the user object 6. For example, every time the user object 6 is attacked, the object control unit 233-2 decreases the size of the UI object 7, which is a ball. With this, the opening of the ball is gradually shown on the field-of-view image 26, and the field of view of the user is reduced. Therefore, the user can recognize the amount of damage given to the user object 6.

In at least one embodiment, the color of the UI object 7 is a color that is the same as or similar to the color of the outer frame of the display 112 on the HMD 110. For example, when the outer frame of the display 112 is black, the color of the UI object 7 is also set to black or a color similar to black. When the UI object 7 moves toward the field of view 3, the black color of the outer frame and the black color of the UI object 7 are in harmony with each other, and the field-of-view image 26 and the outer frame of the display 112 do not have a conspicuous border. The user thus does not have much strange feeling about the UI object 7 to be recognized.

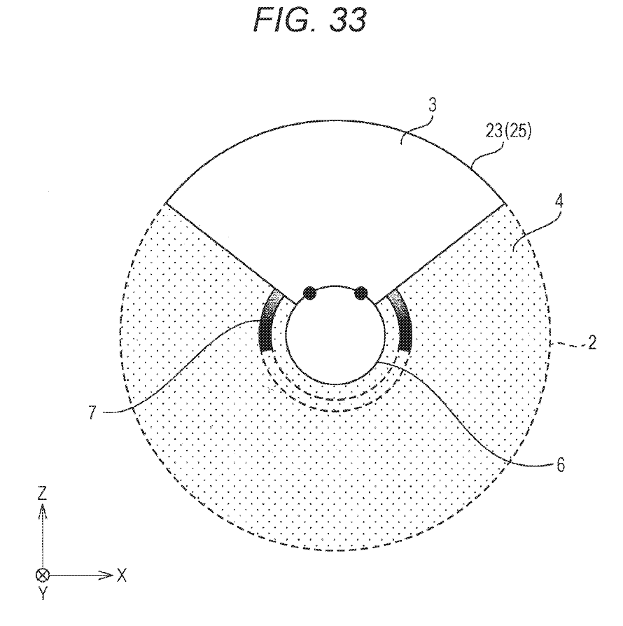

FIG. 33 is a diagram of an example of the UI object 7 according to at least one embodiment of this disclosure. The UI object 7 may be arranged in only a part of the entire direction of the blind spot 4. That is, a portion of UI object 7 that will never enter the field-of-view region 23 is not generated in the virtual space 2. This helps to reduce processing workload in generating virtual space 2.

The control circuit unit 200 may identify, instead of the field-of-view direction, the line-of-sight direction NO as the reference line of sight 5. In this case, when the user changes his or her line of sight, the direction of the virtual camera 1 changes in synchronization with the change in line of sight. Thus, the position of the field-of-view region 23 also changes in synchronization with the change in line of sight. As a result, content of the field-of-view image 26 changes in accordance with the change in line of sight.

[Example of Implementation]

The control blocks of the control circuit unit 200 (detection unit 210, display control unit 220, virtual space control unit 230, storage unit 240, and communication unit 250) may be implemented by a logic circuit (hardware) formed on an integrated circuit (IC chip) or the like, or may be implemented by execution of software with use of a central processing unit (CPU).

In the latter case, the control blocks includes a CPU configured to execute a command of a program, which is software for implementing each function, a read only memory (ROM) or a storage device (those components are referred to as “recording medium”) having recorded thereon the above-mentioned program and various types of data that are readable by a computer (or the CPU), and a random access memory (RAM) to which the above-mentioned program is to be loaded. The computer (or the CPU) reads the above-mentioned program from the above-mentioned recording medium to execute the program, and thus the object of this disclosure is achieved. As the above-mentioned recording medium, “non-transitory tangible media” such as a tape, a disk, a card, a semiconductor memory, and a programmable logic circuit may be used. Further, the above-mentioned program may be supplied to the above-mentioned computer via any transmission medium (for example, a communication network or broadcast waves) that is capable of transmitting the program. This disclosure may be achieved by the above-mentioned program in the form of a data signal embedded in a carrier wave, which is embodied by electronic transmission.

This disclosure is not limited to the above described embodiments, but various modifications may be made within the scope of this disclosure set forth in the appended claims. The technical scope of this disclosure includes an embodiment obtained by appropriately combining technical means disclosed in different embodiments.

For example, when a virtual experience is provided by applying operation through touch with a virtual object to MR or the like, an actual part of the body of the user other than the head may be detected by, for example, a physical/optical method, in place of an operation target object, and it may be determined whether or not the part of the body of the user and the virtual object have touched each other based on the positional relationship between the part of the body and the virtual object. When a virtual experience is provided using a transmissive HMD, the reference line of sight of the user may be identified by detecting movement of the HMD or the line of sight of the user similarly to a non-transmissive HMD.

[Supplementary Note 1]

Specifics according to at least one embodiment of this disclosure are enumerated in the following manner.

(Item 1) A method of providing a virtual space to a user wearing a head mounted display (hereinafter referred to as “HMD”) on a head of the user. The method includes generating a field-of-view image to be output to the head mounted display in the virtual space based on movement of the head mounted display. The method further includes generating an input object with which an input item is associated in the virtual space. The method further includes generating a virtual body configured to move in synchronization with movement of a part of a body of the user other than the head in the virtual space. The method further includes detecting that the input object is moved to a determination region in the virtual space with the virtual body. The method further includes receiving, in response to a detection that the input object is moved to the determination region, input of the input item associated with the input object. When the input object is moved to the determination region, input associated with the input object can be received, and thus it is possible to easily receive input in the virtual space. With this, improving the virtual experience is possible.

(Item 2) A method according to Item 1, in which the input object includes a plurality of parts, and different input items are associated with the plurality of parts, respectively, in which the detecting includes detecting, the input object touching a determination object arranged in the virtual space, that the input object is moved to the determination region, and in which the receiving includes receiving input of one of the different input items, which is associated with one of the plurality of parts of the input object in response to a detection that the input object has touched the determination object. Input can be received by the input object touching the determination object, and thus easily receiving input is possible.

(Item 3) A method according to Item 2, in which the plurality of parts are a plurality of surfaces, and in which the receiving includes receiving, when a first surface of the input object has touched the determination object, input of one of the different input items, which is associated with a second surface having a predetermined positional relationship with the first surface. Input of an input item associated with a surface having a predetermined positional relationship with the touch surface is received, and thus the user can easily recognize the input item.

(Item 4) A method according to Item 2, in which the plurality of parts are a plurality of surfaces, and in which the receiving includes receiving, when a first surface of the input object has touched the determination object, input of one of the different input items, which is associated with the first surface. Input of an input item associated with a surface touching the determination object is received, and thus the user can easily recognize the input item.

(Item 5) A method according to Item 1, in which the input object is a plurality of character objects with which characters are associated as the input items, respectively, in which the detecting includes detecting, when a region defined in the virtual space and a position of at least one of the plurality of character objects have a specific positional relationship, that the at least one of the plurality of character objects is moved to the determination region, and in which the receiving includes receiving input of one of the characters associated with the at least one of the plurality of character objects in the specific positional relationship. Easily receiving input of a plurality of character objects is possible.

(Item 6) A method according to Item 1, in which a plurality of input objects each including a plurality of parts are generated, and different input items are associated with the plurality of parts, respectively, in which the detecting includes detecting, when at least one of the plurality of input objects is set in an input space arranged in the virtual space, that the at least one of the plurality of input objects is moved to the determination region, and in which the receiving includes receiving, in response to a detection that the at least one of the plurality of input objects is set in the input space, input of one of the different input items associated with the at least one of the plurality of input objects set in the input space. Receiving input with a plurality of input objects is possible.

(Item 7) A method according to Item 6, further including completing movement of the plurality of input objects, in which the receiving includes receiving, after completing movement of the plurality of input objects, input of the different input items associated with predetermined surfaces of the plurality of input objects based on positions in the input space of the plurality of input objects set in the input space. When there are a plurality of input objects, easily recognizing completion of input is possible.

(Item 8) A method of providing a virtual experience to a user wearing a head mounted display on a head of the user. The method includes generating an input object with which an input item is associated. The method further includes detecting that the input object is moved to a determination region with a part of a body of the user other than the head. The method further includes and receiving, in response to a detection that the input object is moved to the determination region, input of the input item associated with the input object. When the input object is moved to the determination region, input associated with the input object can be received, and thus easily receiving input in the virtual space is possible. With this, improving the virtual experience of the user is possible.

(Item 9) A system for executing each step of the method of any one of Items 1 to 8.

(Item 10) A computer-readable recording medium having recorded thereon instructions for execution by the system of Item 9.

[Supplementary Note 2]

Specifics according to at least one embodiment of this disclosure are enumerated in the following manner.

(Item 11) A method of providing a virtual space to a user wearing a head mounted display on a head of the user. The method includes generating a field-of-view image to be output to the head mounted display in the virtual space based on movement of the head mounted display. The method further includes generating, in the virtual space, a user interface (hereinafter referred to as “UI”) object including an operation part at a first position, which is configured to receive an instruction from the user; generating, in the virtual space, a virtual body configured to move in synchronization with movement of a part of a body of the user other than the head. The method further includes detecting that the operation part is selected with the virtual body. The method further includes detecting that the operation part is moved in a certain direction with the virtual body with the operation part being selected with the virtual body. The method includes selecting a predetermined option based on the instruction to the UI object while the operation part is located at a second position different from the first position with the operation part being selected with the virtual body.

According to the method described above, an option is selected by selecting and moving the operation part with the virtual body, and thus the user can recognize the fact that an operation is performed reliably. With this, improving the virtual experience is possible.

(Item 12) A method according to Item 11, in which a first distance range including the second position and a second distance range including a third position different from the second position and the first position are set in the certain direction with respect to the UI object, and in which the selecting of a predetermined option includes selecting the predetermined option when the operation part is located in the first distance range and selecting an option different from the predetermined option when the operation part is located in the second distance range.

According to the method described above, switching between and selecting a plurality of options in a manner that matches the operation feeling of the user.

(Item 13) A method according to Item 11 or 12, in which the UI object has a display region provided therein, and in which first information is displayed on the display region when the operation part is located at the first position, and second information, which depends on the option, is displayed on the display region when the operation part is located at the second position.

According to the method described above, presenting an option in a manner that matches the operation feeling of the user by presenting the second information, which depends on the predetermined option, on the display area when the operation part is located at a location different from the first position is possible.

(Item 14) A method according to any one of Items 11 to 13, in which the part of the body is moved in synchronization with the virtual body through use of a controller touching the part of the body, and in which the method further includes applying vibration to the part of the body via the controller when the predetermined option is selected.

According to the method described above, the user can reliably recognize the fact that the option is selected.

(Item 15) A method according to any one of Items 11 to 14, further including returning the operation part to the first position when selection of the operation part with the virtual body is canceled at the second position. The method further includes maintaining a selected state of the predetermined option when the operation part has returned to the first position.

According to the method described above, canceling the selected state in a manner that matches the operation feeling of the user, and maintaining the option is possible.

(Item 16) A method according to Item 15, further including selecting the predetermined option when the operation part has returned to the first position. According to the method described above, selecting an option through a simple operation of the user is possible.

(Item 17) A method of providing a virtual experience to a user wearing a head mounted display on a head of the user. The method includes generating a user interface (hereinafter referred to as “UI”) object including an operation part at a first position, which is configured to receive an instruction from the user. The method further includes detecting that the operation part is selected with a part of a body of the user other than the head; detecting that the operation part is moved in a certain direction with the part of the body with the operation part being selected with the part of the body. The method further includes selecting a predetermined option based on the instruction to the UI object while the operation part is located at a second position different from the first position with the operation part being selected with the part of the body.

According to the method described above, an option is selected by selecting and moving the operation part with the virtual body, and thus the user can recognize the fact that an operation is performed reliably. With this, improving the virtual experience of the user is possible.

(Item 18) A system for executing each step of the method of any one of Items 11 to 17.

(Item 19) A computer-readable recording medium having recorded thereon instructions for executing by the system of Item 18.

[Supplementary Note 3]

Specifics according to at least one embodiment of this disclosure are enumerated in the following manner.

(Item 20) A method of providing a virtual space to a user wearing a head mounted display (hereinafter referred to as “HMD”) on a head of the user. The method includes identifying a reference line of sight of the user in the virtual space. The method further includes identifying a virtual camera, which is arranged in the virtual space and is configured to set a field-of-view region to be recognized by the user based on the reference line of sight. The method further includes arranging an object capable of being moved to a field of view of the virtual camera in a blind spot of the virtual camera. The method further includes moving, in response to an event in the blind spot, the object toward the field of view by a movement amount corresponding to a direction in which the event has occurred. The method further includes generating a field-of-view image based on the field-of-view region. The method further includes displaying the field-of-view image on the HMD. With this, an operability in the virtual space is improved.

(Item 21) A method according to Item 20, in which the object has a shape of surrounding the virtual camera, and the object is rotated by a rotation amount corresponding to the direction.

(Item 22) A method according to Item 21, in which the object is rotated in a rotation direction that is based on the direction.

(Item 23) A method according to Item 21 or Item 22, in which the object has gradated colors so that a first color of a first part of the object, which requires a smaller movement amount to enter the field of view, transitions to a second color of a second part of the object, which requires a larger movement amount to enter the field of view.

(Item 24) A method according to Item 21 or 22, in which a transmittance of color applied to a first part of the object, which requires a smaller movement amount to enter the field of view, gradually changes to a transmittance of color applied to a second part of the object, which requires a larger movement amount to enter the field of view.

(Item 25) A system for executing each step of the method of any one of Items 20 to 24.

(Item 26) A computer-readable recording medium having recorded thereon the instructions for executing by the system of Item 25.

1-10. (canceled)

11. A method of providing a virtual space to a user comprising:
generating a virtual space;
displaying a field-of-view image of the virtual space using a head mounted display (HMD);
displaying an input object in the virtual space;
displaying, in the virtual space, a virtual body corresponding to a part of a body of the user other than the user's head;
moving the virtual body in synchronization with a detected movement of the part of the body of the user;
detecting movement of the input object, using the virtual body, to a determination region in the virtual space; and
receiving, in response to a detection that the input object is moved to the determination region, an input associated with information contained in the input object.

12. The method according to claim 11, wherein the input object comprises a plurality of sub-objects, and each sub-object of the plurality of sub-objects contains different information from other sub-objects of the plurality of sub-objects.

13. The method of claim 12, wherein the detecting of the movement of the input object to the determination region comprises determining that input object moved to the determination region in response to at least one sub-object of the plurality of sub-objects touching the determination region in the virtual space.

14. The method of claim 12, wherein the receiving of the input comprises receiving information from multiple sub-objects of the plurality of sub-objects in response to a determination that more than one sub-object of the plurality of sub-objects is moved to the determination region.

15. The method according to claim 11, wherein the input object comprises a plurality of surfaces, and the receiving of the input comprises receiving the input associated with a first surface of the plurality of surfaces in response to a second surface of the plurality of surfaces touching a determination object.

16. The method according to claim 11, wherein the input object comprises a plurality of surfaces, and the receiving of the input comprises receiving the input associated with a first surface of the plurality of surfaces in response to the first surface touching a determination object.

17. The method according to claim 11,
wherein the input object comprises a plurality of character objects, and
the receiving the input comprises receiving input of one at least one character associated with at least one character object of the plurality of character objects in response to a determination that the at least one character object has a predetermined positional relationship with the determination region.

18. The method according to claim 14, wherein the receiving of the input comprises receiving the input following completion of moving of the more than one sub-object of the plurality of sub-objects.

19. A method of providing a virtual experience comprising:
generating a virtual space;
defining a user object in the virtual space, wherein the user object is associated a user;
displaying a field-of-view image of the virtual space using a head mounted display (HMD);
generating a user interface (UI) object in the virtual space;
generating an enemy object in the virtual;
detecting an attack by the enemy object on the user object, wherein a location of the attack is in the virtual space, and the location of the attack is outside of the field-of-view image; and
rotating the UI object into the field-of-view image in response to detecting the attack.

20. The method of claim 19, wherein the rotating of the UI object comprises rotating the UI object by a rotation magnitude based on the location of the attack.

21. The method of claim 19, wherein the generating of the UI object comprises generating the UI object have a transmission gradient.

22. The method of claim 21, wherein the generating of the UI object comprises generating the UI objecting having a lowest transmissivity in a region opposite a line of sight of the user.

23. The method of claim 19, wherein the generating of the UI object comprises generating the UI object having a color gradient.

24. The method of claim 19, wherein the displaying of the field-of-view image comprises displaying the field-of-view image free of the UI object prior to detecting the attack.

25. The method of claim 19, wherein the generating of the UI object comprises generating the UI object having a ball shape.

26. The method of claim 19, wherein the rotating of the UI object comprises selecting a direction of rotating the UI object based on the location of the attack.

27. A system for providing a virtual experience comprising:
a head mounted display (HMD);
a processor; and
a non-transitory computer readable medium connected to the processor, wherein the processor is configured to execute instructions stored on the non-transitory computer readable medium for:
generating a virtual space;
generating instructions for displaying a field-of-view image of the virtual space on the HMD;
generating instructions for displaying an input object in the virtual space;
generating instructions for displaying, in the virtual space, a virtual body corresponding to a part of a body of the user other than the user's head;
moving the virtual body in synchronization with a detected movement of the part of the body of the user;
detecting movement of the input object, using the virtual body, to a determination region in the virtual space; and
receiving, in response to a detection that the input object is moved to the determination region, an input associated with information contained in the input object.

28. The system of claim 27, further comprising a controller for communicating with the processor, wherein the processor is configured to move the virtual body based on detected movement of the controller.

29. The system of claim 27, wherein the processor is configured to generate instructions for displaying the input object comprising a plurality of sub-objects, and each sub-object of the plurality of sub-objects contains different information from other sub-objects of the plurality of sub-objects.

30. The system of claim 29, wherein the processor is configured to receive the input comprises information from multiple sub-objects of the plurality of sub-objects in response to a determination that more than one sub-object of the plurality of sub-objects is moved to the determination region.
